(19) United States
(12) Patent Application Publication
(10) Pub. No.: US 2021/0319586 A1
(43) Pub. Date: Oct. 14, 2021

(54) VEHICLE WHEEL ALIGNMENT SYSTEMS AND METHODS USING DRIVE DIRECTION

(71) Applicant: Snap-On Incorporated, Kenosha, WI (US)

(72) Inventors: Steven W. ROGERS, Conway, AR (US); David A. JACKSON, Point Roberts, WA (US); Eric R. SELLERS, Conway, AR (US); Ronald D. SWAYNE, Sherwood, AR (US); James Rodney HARRELL, Greenbrier, AR (US); Chance ROBINSON, North Little Rock, AR (US); Robert J. D'AGOSTINO, Conway, AR (US)

(73) Assignee: Snap-On Incorporated, Kenosha, WI (US)

(21) Appl. No.: 17/358,555

(22) Filed: Jun. 25, 2021

Related U.S. Application Data
(63) Continuation-in-part of application No. 16/904,407, filed on Jun. 17, 2020.
Application No. 16/904,407 is a continuation of application No. 16/423,503, filed on May 28, 2019, now Pat. No. 10,692,241.
Application No. 16/423,503 is a continuation of application No. 15/678,825, filed on Aug. 16, 2017, now Pat. No. 10,347,006.
(60) Provisional application No. 62/377,954, filed on Aug. 22, 2016.
(60) Provisional application No. 62/375,716, filed on Aug. 16, 2016.

(51) Int. Cl. G06T 7/73; G01B 11/275; G06T 7/60; H04N 5/247

(52) U.S. Cl. CPC G06T 7/74; G01B 11/2755; G06T 7/60; H04N 5/247; G06T 2207/30252; G01B 2210/143; G01B 2210/26; G01B 2210/30; G01B 2210/12

(57) ABSTRACT

A vehicle wheel alignment system includes a pair of wheel mounted targets, a pair of reference targets mounted to a stationary reference, a pair of gravity sensors, and a pair of vehicle-mounted active heads mounted on first and second sides of the vehicle. The active heads each have an image sensor for producing image data of one of the reference targets and one of the wheel mounted targets. The gravity sensors are disposed on each side of the vehicle in a known relationship to either the respective reference targets or the image sensors. A data processor calculates, using the image data, a plurality of poses of the wheel mounted targets as the vehicle wheels rotate; calculates a vehicle drive direction using the target poses and a measured orientation relative to gravity from the gravity sensors; and calculates a wheel alignment measurement using the vehicle drive direction.

### CROSS-REFERENCE TO RELATED APPLICATIONS

This application claims the benefit of U.S. patent application Ser. No. 16/904,407, filed Jun. 17, 2020, which claims the benefit of U.S. patent application Ser. No. 16/423,503, filed May 28, 2019, now U.S. Pat. 10,692,241, which claims the benefit of U.S. patent application Ser. No. 15/678,825, filed Aug. 16, 2017, now U.S. Pat. No. 10,347,006, which claims the benefit of U.S. Provisional Patent Applications No. 62/375,716, filed Aug. 16, 2016, and No. 62/377,954, filed Aug. 22, 2016, the disclosures of which are hereby incorporated by reference in their entireties.

### TECHNICAL FIELD

The present subject matter relates to equipment and techniques for measuring alignment of wheels of a vehicle.

### BACKGROUND

Wheel alignment equipment is used to measure the alignment of the wheels of a vehicle. Based on the measurements, adjustments to be made to the vehicle and wheels are determined in order to bring the wheels into alignment. As part of the alignment measurement process, the alignment equipment commonly measures the relative alignment of wheels disposed on each side of the vehicle separately (e.g., on a left side and a right side). In order to relate measurements taken on one side of the vehicle with measurements taken on the other/opposite side of the vehicle, the alignment equipment generally needs to have a precise reference for relating the measurements taken on the one side to the measurements taken on the other/opposite side.

Alignment systems include conventional aligners, visual alignments, and self-calibrating aligners. In conventional aligners, a toe gauge is provided in one wheel alignment head attached to a vehicle wheel on one side of the vehicle. The toe gauge can measure an angle to another toe gauge provided in another wheel alignment head that is attached to a wheel on the other side of the vehicle. The aligner can then relate alignment measurements taken on the one side of the vehicle with alignment measurements taken on the other side of the vehicle based on the toe gauge measurement.

However, the toe gauges used in conventional aligners are attached to the alignment heads, and generally require use of a boom extending from the alignment head to look around the wheel that it is attached to. The presence of such booms results in large, heavy, and expensive alignment heads, and the toe gauges can be obstructed easily by the vehicle body since they are in a fixed position on the alignment head (e.g., any rotation of the alignment head, for example resulting from the rolling forward or backward of the vehicle, may result in the toe gauge being obstructed).

In visual aligners (e.g., camera-based aligners), a solid beam mounted to a fixed structure (e.g., a shop wall) holds two alignment cameras each looking down a respective side of the vehicle. The relative position of the two alignment cameras is maintained fixedly by the solid beam and, once the relative position is measured and stored in memory, the relative position of the alignment cameras can be used to relate alignment measurements taken on the one side of the vehicle (by one alignment camera) with alignment measurements taken on the other side of the vehicle (by the other alignment camera).

However, the cameras of the visual aligners are fixedly attached to a large beam. The large beam can get in the way of shop operations, and the presence of the large beam results in a system that is large, heavy, and expensive. Additionally, the large beam has minimum configurations options, and any deformation of the beam results in alignment measurement inaccuracies.

In the case of self-calibrating aligners, a calibration camera is provided in addition to two alignment cameras each looking down a respective side of the vehicle. The calibration camera has a fixed and known relative position to one of the two alignment cameras, and the calibration camera is oriented so as to point across a width of the vehicle towards the other of the two alignment cameras. Specifically, the calibration camera is oriented so as to point towards a calibration target that is attached to the other alignment camera, where the calibration target itself has a fixed and known relative position to the other alignment camera. In this set-up, the calibration can, as often as is required, obtain an image of the calibration target. In turn, based on the known relative positions between the calibration camera and the one alignment camera and between the calibration target and the other alignment camera, the alignment system can precisely determine the relative positions of the two alignment cameras. The determined relative position information is used to relate measurements taken by the alignment cameras on both sides of the vehicle.

However, while the self-calibrating aligners address some of the drawbacks of the conventional and visual aligners noted above, the self-calibrating aligners rely on a calibration camera or a calibration target being attached to each alignment camera. As a result, the aligner generally needs to be set-up in such a manner that the calibration camera (attached to one alignment camera) can see the calibration target (attached to the other alignment camera) while the alignment cameras are each oriented to see vehicle wheel alignment targets on a respective side of the vehicle. This set-up complexity restricts the acceptable locations of the alignment cameras (each having one of the calibration camera and the calibration target attached thereto), and limits some of the acceptable locations where the system can be used.

In order to address the drawbacks detailed above, there exists a need for a side-to-side reference that can be used when measuring the alignment of a vehicle.

### SUMMARY

The teachings herein alleviate one or more of the above noted problems with conventional alignment systems.

In accordance with one aspect of the disclosure, a wheel alignment system comprises a pair of first and second passive heads, each comprising a target, each for mounting in association with one wheel of a first pair of wheels disposed on first and second sides, respectively, of a vehicle that is to be measured by operation of the wheel alignment system; a pair of reference targets for mounting to a stationary reference, the pair of reference targets including a first reference target disposed on one of the first and second sides of the vehicle, and a second reference target disposed on the other of the first and second sides of the vehicle; a pair of first and second active heads for mounting in association with the first and second sides of the vehicle, respectively, the first active head comprising a first image sensor, the second active head comprising a second image sensor, the first image sensor producing image data of the first passive head and of the first reference target, the second image sensor producing image data of the second passive head and of the second reference target; a first gravity sensor and a second gravity sensor, the first and second gravity sensors each disposed in a known relationship to a respective one of the first and second reference targets or a respective one of the first and second image sensors for measuring a sensed orientation relative to gravity on the first and second sides of the vehicle, respectively; and a data processor. The data processor is for performing the steps of calculating, using the image data, a plural number of poses of each of the first and second passive heads as the first pair of wheels is rotated; calculating a drive direction of the vehicle using the calculated poses of the first and second passive heads and the sensed orientation relative to gravity on the first and second sides of the vehicle; and calculating a wheel alignment measurement using the vehicle drive direction.

In some embodiments, calculating the drive direction of the vehicle comprises calculating a drive direction of the first side of the vehicle using the calculated poses of the first target, and a drive direction of the second side of the vehicle using the calculated poses of the second target; calculating a gravity direction on the first side of the vehicle using the measured orientation relative to gravity of the first gravity sensor, and a gravity direction on the second side of the vehicle using the measured orientation relative to gravity of the second gravity sensor; and transforming the drive direction and gravity direction of the first side of the vehicle into a common coordinate system with the drive direction and gravity direction of the second side of the vehicle.

In some embodiments, the first active head includes the first gravity sensor, and the second active head includes the second gravity sensor.

The active heads may be for mounting to a stationary reference. The first and second active heads may be for mounting to the vehicle that is to be measured by operation of the wheel alignment system. The first and second active heads may be for mounting in association with a second pair of wheels disposed on the first and second sides of the vehicle.

In accordance with a further aspect of the disclosure, a method for measuring an alignment of a vehicle includes attaching a pair of first and second passive heads, each comprising a target, in association with a first pair of wheels disposed on first and second sides, respectively, of the vehicle to be measured; providing a pair of reference targets mounted to a stationary reference, the pair of reference targets including a first reference target disposed on one of the first and second sides of the vehicle, and a second reference target disposed on the other of the first and second sides of the vehicle; capturing, using a first image sensor of a first active head mounted in association with the first side of the vehicle, image data of the first passive head and of the first reference target; capturing, using a second image sensor of a second active head mounted in association with the second side of the vehicle, image data of the second passive head and of the second reference target; measuring, using a first gravity sensor disposed in a known relationship to the first reference target or the first image sensor, an orientation relative to gravity on the first side of the vehicle; measuring, using a second gravity sensor disposed in a known relationship to the second reference target or the second image sensor, an orientation relative to gravity on the second side of the vehicle; processing the image data from the image sensors to calculate a plural number of poses of each of the first and second passive heads as the first pair of wheels is rotated; calculating a drive direction of the vehicle using the calculated poses of the first and second passive heads and the measured orientation relative to gravity on the first and second sides of the vehicle; and calculating a wheel alignment measurement using the vehicle drive direction.

In some embodiments, calculating the drive direction of the vehicle comprises calculating a drive direction of the first side of the vehicle using the calculated poses of the first target, and a drive direction of the second side of the vehicle using the calculated poses of the second target; calculating a gravity direction on the first side of the vehicle using the measured orientation relative to gravity of the first gravity sensor, and a gravity direction on the second side of the vehicle using the measured orientation relative to gravity of the second gravity sensor; and transforming the drive direction and gravity direction of the first side of the vehicle into a common coordinate system with the drive direction and gravity direction of the second side of the vehicle.

In accordance with a further aspect of the disclosure, a wheel alignment system comprises a pair of first and second passive heads, each comprising a target, each for mounting in association with one wheel of a first pair of wheels disposed on first and second sides, respectively, of a vehicle that is to be measured by operation of the wheel alignment system; a pair of reference targets for mounting to a stationary reference, the pair of reference targets including a first reference target disposed on one of the first and second sides of the vehicle, and a second reference target disposed on the other of the first and second sides of the vehicle; a pair of first and second active heads for mounting in association with the first and second sides of the vehicle, respectively, the first active head comprising a first image sensor, the second active head comprising a second image sensor, the first image sensor producing image data of the first passive head and of the first reference target, the second image sensor producing image data of the second passive head and of the second reference target; a first common direction sensor and a second common direction sensor, the first and second common direction sensors each disposed in a known relationship to a respective one of the first and second reference targets or a respective one of the first and second image sensors for measuring a common direction on the first and second sides of the vehicle, respectively; and a data processor. The data processor is for performing the steps of calculating, using the image data, a plural number of poses of each of the first and second passive heads as the first pair of wheels is rotated; calculating a drive direction of the vehicle using the calculated poses of the first and second passive heads and the sensed common direction on the first and second sides of the vehicle; and calculating a wheel alignment measurement using the vehicle drive direction.

In some embodiments, the first and second common direction sensors each comprise a magnetometer for measuring a direction to the magnetic north pole on one of the first and second sides of the vehicle, respectively. In some embodiments, the first and second common direction sensors each comprise a gyroscope for measuring a direction on one of the first and second sides of the vehicle, respectively. In some embodiments, the first and second common direction sensors each comprise an absolute orientation sensor for measuring a direction on one of the first and second sides of the vehicle, respectively.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIGS. 1A and 2A show illustrative side-to-side reference systems that may be used in wheel alignment and other systems and procedures in accordance with the principles of the disclosure.

FIGS. 1B and 2B are block diagrams showing side-to-side reference systems such as those shown in FIGS. 1A and 2A in use in wheel alignment procedures in accordance with the principles of the disclosure.

FIGS. 3A and 4A show illustrative fixed active-head wheel alignment systems that may be used in wheel measurement procedures in accordance with the principles of the disclosure.

FIGS. 3B and 4B are high-level flow diagrams showing steps involved in use of fixed active-head wheel alignment systems such as those shown in FIGS. 3A and 4A in wheel measurement procedures in accordance with the principles of the disclosure.

FIG. 5A shows an illustrative fixed active-head wheel alignment system used in wheel alignment procedures in accordance with the principles of the disclosure.

FIG. 5B is a high-level flow diagrams showing steps involved in use of a fixed active-head wheel alignment system such as that of FIG. 5A in a wheel alignment procedure in accordance with the principles of the disclosure.

FIGS. 6A and 6C show illustrative side-to-side reference systems used in four-wheel alignment procedures in accordance with the principles of the disclosure.

FIG. 6B is a high-level flow diagram showing steps involved in use of a side-to-side reference system such as that of FIG. 6A in a wheel alignment procedure in accordance with the principles of the disclosure.

FIG. 7 shows a mount used to attach an active or passive reference pod to a rack, lift, or vehicle lift in accordance with the principles of the disclosure.

FIG. 8A shows elements involved in performing a calibration procedure for a side-to-side reference system such as those shown in FIGS. 1A and 2A.

FIG. 8B is a high-level flow diagram showing steps involved in calibration of a side-to-side reference system such as those shown in FIGS. 1A, 2A, and 8A.

FIG. 9 is a simplified functional block diagram of a computer hardware platform that may be configured as a processing platform of a wheel alignment system such as those described throughout the disclosure.

FIG. 10 shows an illustrative fixed active-head wheel alignment system using drive direction that may be used in wheel measurement procedures in accordance with the principles of the disclosure.

FIG. 11 is a diagram showing drive direction principles of operation according to the disclosure.

FIGS. 12A-12C illustrate vectors relevant to drive direction principles of operation according to the disclosure.

FIG. 13 depicts a methodology for determining the orientation of an alignment lift according to the disclosure.

FIGS. 14A-14B are high-level flow diagrams showing steps involved in use of a fixed active-head wheel alignment system such as that of FIG. 10 in a wheel alignment procedure in accordance with the principles of the disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to improved equipment and approaches to performing vehicle wheel alignment, including improved equipment and approaches for performing alignment measurements of wheels disposed on opposite sides of a vehicle.

In order to address the drawbacks detailed above, a side-to-side reference is provided that can be used when measuring the alignment of a vehicle, and that is not necessarily attached to the wheel alignment heads or to the alignment cameras. The side-to-side reference can therefore be disposed or installed in many different locations, so as to be seen or referred to easily by the vehicle wheel alignment measuring system. Such a side-to-side reference may enable use of alignment heads with simplified streamlined designs (e.g., with lower complexity).

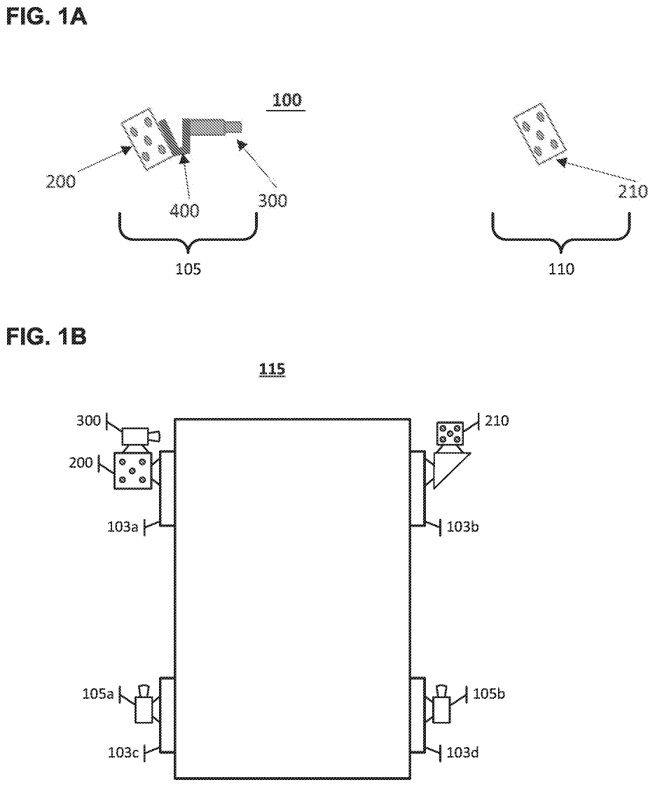

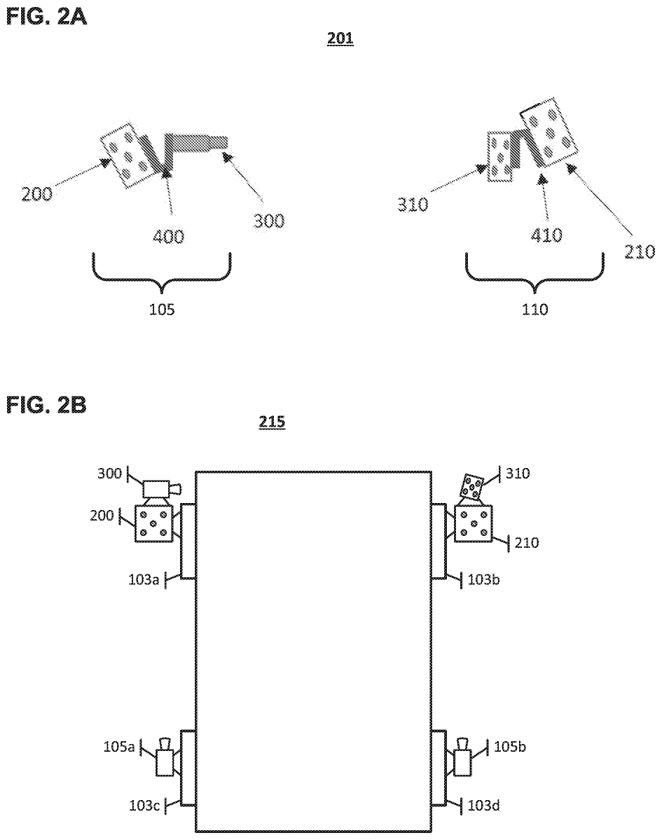

FIG. 1A shows an illustrative side-to-side reference system 100 that may be used in accordance with the principles of the disclosure. As shown in FIG. 1A, the side-to-side reference system 100 includes an active reference pod 105 and a passive reference pod 110 that respectively include first and second reference targets 200, 210. The active reference pod 105 having the first reference target 200 has a reference image sensor such as a calibration camera 300 (or other type of image sensor) attached thereto. The calibration camera 300 has a fixed and known relative position and orientation to the first reference target 200. Furthermore, the calibration camera 300 is disposed so as to be oriented towards (and to look across to) the passive reference pod 110 including the second reference target 210 when the first and second reference targets 200 and 210 are used with a wheel alignment system. In use in a wheel alignment system, the active and passive reference pods 105 and 100 can be positioned anywhere as long as the calibration camera 300 of the active reference pod 105 can see the second reference target 210 of the passive reference pod 110, as shown in FIG. 1A, and as long as the first and second reference targets 200 and 210 can be seen by respective alignment cameras of the wheel alignment system.

As shown, each target 200, 210 has a characteristic pattern thereon (e.g., on a surface thereof), such as a characteristic pattern forms by dots, circles, or other geometric shapes. The geometric shapes may be of the same or different colors or sizes. The pattern formed by the geometric shapes is generally rotationally asymmetric such that the rotational orientation of the target can be determined based on the observed pattern. More generally, while targets having patterns thereon are shown in FIG. 1A, other types of targets can be used including targets including light emitting diodes (LEDs), targets having highly reflective surfaces, three dimensional targets in which patterns (or LEDs) are disposed on multiple different planes or surfaces, or the like.

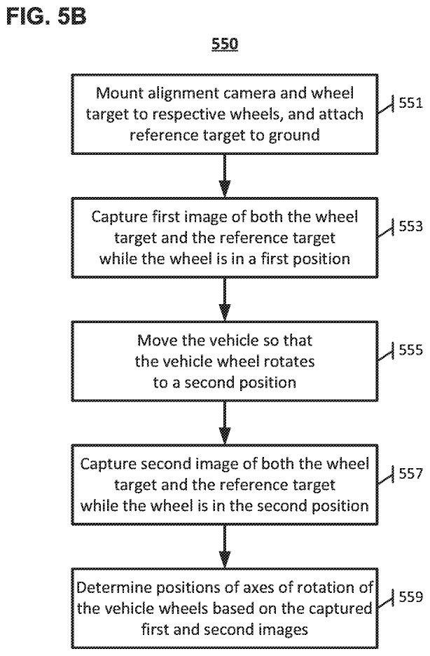

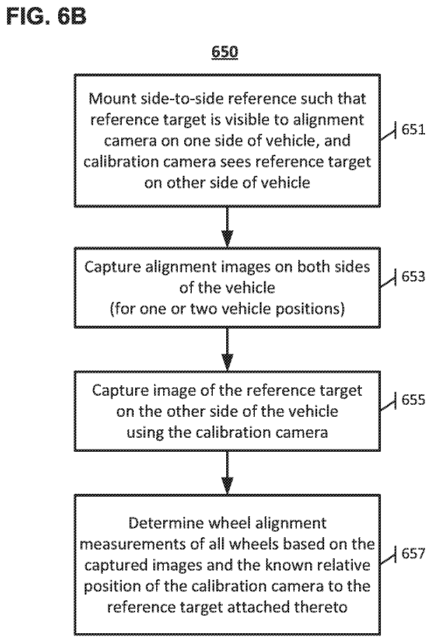

The side-to-side reference system 100 is shown as it may be used in a wheel alignment system 115 in the illustrative example of FIG. 1B. In the example, a vehicle has four wheels 103a-103d that are undergoing a wheel alignment procedure and that each have a respective alignment head mounted thereto. The side-to-side reference system 100 is mounted as part of passive alignment heads to a set of wheels 103a, 103b disposed on opposite sides of the vehicle, although in other examples the side-to-side reference system 100 can be mounted to a fixed or stationary surface (see, e.g., FIGS. 6A and 6C, described below). For example, the active reference pod 105 and first reference target 200 may be mounted as a first passive alignment head to a first wheel 103a of the vehicle on a first side of the vehicle using a wheel mounting clamp or other appropriate mounting mechanism. The calibration camera 300, which forms part of the active reference pod 105 and is fixedly attached to the first reference target 200, is also mounted to the first wheel 103a via the fixed attachment bracket of the active reference pod 105. The passive reference pod 110 and second reference target 210 are mounted as a passive alignment head to a second wheel 103b of the vehicle on a second side of the vehicle (e.g., opposite to the first side) using a wheel mounting clamp or other appropriate mounting mechanism. The calibration camera 300 (of the active reference pod 105) and second reference target 210 (of the passive reference pod 110) are disposed such that the calibration camera 300 can see the second reference target 210 across the vehicle.

In addition, in the illustrative example of FIG. 1B, other components of a visual aligner are shown. First and second active alignment heads, respectively including first and second image sensors (e.g., alignment cameras 105a and 105b, or other image sensors), are mounted to third and fourth wheels 103c and 103d disposed on opposite sides of the vehicle, although in other embodiments the first and second alignment cameras 105a and 105b may be mounted to fixed references (e.g., mounted to ground, a wall, a floor, a tripod, a rack, a lift, or the like) with passive alignment heads mounted to the third and fourth wheels. The first alignment camera 105a is disposed such that it can see the active reference pod 105 including the first reference target 200 mounted to the first wheel 103a on the same side of the vehicle as the first alignment camera 105a, and the second alignment camera 105b is disposed such that it can see the passive reference pod 110 including the second reference target 210 mounted to the second wheel 103b on the same side of the vehicle as the second alignment camera 105b. As noted above, the first reference target 200 is fixedly attached to the calibration camera 300 and mounted to the first wheel 103a by use of a wheel clamp, for example, while the second reference target 210 is mounted to the second wheel 103b by use of a wheel clamp.

As noted above, the calibration camera 300 has a known relative position to the first reference target 200 in the active reference pod 105. The relative positional relationship can either be fixed at the time of manufacture and determined at that time, or fixed at a later time and measured through a calibration process. In some examples, the relative positional relationship can be adjustable, and can be measured through the calibration process following any adjustment in the positional relationship. In use, the relative positions of the first and second reference targets 200 and 210 can thus be determined based at least in part on the known (e.g., measured) relative position of the calibration camera 300 to the first reference target 200, and on the relative position of the calibration camera 300 to the second reference target 210 as determined based on one or more perspective images (and associated image data) of the second reference target 210 obtained using the calibration camera 300. In turn, wheel alignments can be determined based on the determined relative positions of the first and second reference targets 200 and 210 in combination with other alignment measurements. Specifically, when performing a wheel alignment measurement, the first and second reference targets 200 and 210 are positioned such that: (i) the calibration camera 300 can see the second reference target 210; and (ii) alignment cameras of the wheel alignment system can see the first and second reference targets 200 and 210. The relative positions of the first and second reference targets 200 and 210 can then be measured, e.g. based on one or more perspective images (and associated image data) of the second reference target 210 captured by the calibration camera 300.

Further, each alignment camera (e.g., 105a and 105b) of the wheel alignment system (e.g., 115) can see at least a respective one of the first and second reference targets 200 and 210, and the relative positions of the alignment cameras 105a and 105b can thus be determined based on the relative positions of the first and second reference targets 200 and 210 determined based on the images captured by the calibration camera 300. In this manner, measurements obtained by the alignment cameras 105a, 105b of the wheel alignment system 115 on opposite sides of the vehicle can be correlated to each other to determine the vehicle's overall wheel alignment measurements.

In one example, a wheel alignment system determines wheel alignments based on the determined relative positions of the first and second reference targets 200 and 210 in combination with other alignment measurements as detailed in the following paragraphs. In particular, a spatial relationship between the active reference pod 105 and the passive reference pod 110 is determined according to the image data produced by the reference image sensor 300 and including a perspective representation of at least one target of the passive reference pod 110. The determined spatial relationship is then used to establish the positional relationship between measurements performed by the alignment cameras 105a and 105b.

The wheel alignments are determined by transforming coordinates measured relative to one target (e.g., 200) into coordinates measured relative to the other target (e.g., 210). The transformation is performed using a chain of coordinate transformations from the first to the second reference target as depicted in the following Equation 1:

Tᵣₗ=T₁(T₀)

Equation 1: Transformation from First Reference Target 200 to Second Reference Target 210

In Equation 1, To is the 3D rigid body transformation from the first reference target coordinate system 200 to the calibration camera coordinate system 300, T₁ is the 3D rigid body transformation from the calibration camera coordinate system 300 to the second reference target coordinate system 210, and Tᵣₗ is the composite 3D rigid body transformation from the first reference target coordinate system 200 to the second reference target coordinate system 210.

In Equation 1 and in all subsequent equations, each transformation Tᵢ( ) denotes a three dimensional rigid body transformation (rotation and/or translation) from one coordinate system to another. A number of different coordinate transformation formalisms can be used to implement the transformations defined herein, including but not limited to: homogeneous transformation matrices, separate rotation matrices and translation vectors in Euclidean coordinates, rotations expressed as quaternions, etc. The disclosure is not limited to any specific coordinate transformation used or described, but can generally be used with any appropriate coordinate transformation.

FIG. 2A shows an alternative form of a side-to-side reference system 201. Instead of the passive reference pod 110 including only a single second reference target 210 as shown in FIG. 1A, the passive reference pod 110 of FIG. 2A includes a calibration target 310 rigidly attached to the second reference target 210 by a target mount 410. In this way, the second reference target 210 and its associated calibration target 310 in the passive reference pod 110 can be targets that are not co-planar, for example, in order to provide for a wider range of positioning of the passive reference pod 110 and the second reference target 210 during alignment processes. For instance, FIG. 2B shows an illustrative visual alignment system that makes use of the side-to-side reference 201. As shown in FIG. 2B, the calibration target 310 may substantially face the calibration camera 300 (e.g., a direction across the vehicle) while the second reference target 210 faces the second alignment camera 105b (e.g., a direction towards a front or rear of the vehicle, along a same side of the vehicle).

With the known fixed relationship of the calibration camera 300 to the first reference target 200 in the active reference pod 105 and the known fixed relationship of the calibration target 310 to the second reference target 210 in the passive reference pod 110, the relative position of the first and second reference targets 200 and 210 can be determined based on a measurement of the position of the calibration target 310 with respect to the calibration camera 300 based on one or more perspective images (and associated image data) of the calibration target 310 captured by the calibration camera 300.

The chain of coordinate transformations used to transform coordinates expressed relative to the first reference target 200 to coordinates expressed relative to the second reference target 210 by way of an intermediate coordinate transformation is depicted in the following Equation 2:

Tᵣₗ=T₂(T₁(T₀))

Equation 2: Transformation from First to Second Reference Target Using an Intermediate Coordinate Transformation

In Equation 2, To is the 3D rigid body transformation from the first reference target coordinate system 200 to the calibration camera coordinate system 300, T₁ is the 3D rigid body transformation from the calibration camera coordinate system 300 to the calibration target coordinate system 310, T₂ is the 3D rigid body transformation from calibration target coordinate system 310 to the second reference target coordinate system 210, and Tᵣₗ is the composite 3D rigid body transformation from the first reference target coordinate system 200 to the second reference target coordinate system 210. Each transformation Tᵢ in Equation 1 denotes a three dimensional rigid body transformation (rotation and/or translation) from one coordinate system to another.

In this example, the active and passive reference pods 105 and 110 and their first and second reference targets 200 and 210 are positioned such that the calibration camera 300 of the active reference pod 105 can see the calibration target 310 of the passive reference pod 110 and such that the alignment cameras (e.g., 105a and 105b in FIG. 2B) of the wheel alignment system 215 can respectively see the active and passive reference pods 105 and 110 and their first and second reference targets 200 and 210. Note that in each of these examples, any time the active and/or passive reference pod 105 and/or 110 or the reference target 200 and/or 210 is moved, new measurement of the relative position of the active reference pod 105 to the passive reference pod 110 (measured as a relative position of the calibration target 310 and the calibration camera 300) should be obtained.

During a wheel alignment procedure, the vehicle having its wheel alignment measured is commonly rolled forward and/or backward to cause the wheels to rotate, for example to measure run-out or compensation of the wheels. Specifically, measurements of wheel alignment targets of alignment heads mounted to the wheels are taken with the vehicle in a first position, the vehicle is then moved to a second position such that its wheels rotate forward or backward (e.g., by approximately 20.degree. or more), and measurements of the wheel alignment targets mounted to the wheels are taken with the vehicle in the second position.

In general, in conventional and certain other types of aligners, in order for wheel alignment targets forming part of passive alignment heads mounted or attached to wheels of the vehicle (and/or for wheel alignment cameras or other wheel alignment sensors or measurement components forming part of active alignment heads mounted or attached to wheels of the vehicle) to maintain a proper orientation when the vehicle is in both the first and second positions, the wheel alignment targets (and/or wheel alignment cameras or other wheel alignment sensors) rotate around a shaft. Specifically, each target, camera, or sensor that is configured to be mounted or attached as part of an alignment head to a vehicle wheel is attached to a wheel clamp of the alignment head that can be securely clamped onto the wheel, and the target, camera, or sensor can rotate with respect to the wheel clamp around a rotation axis of the shaft. Thus, as the vehicle wheel rotates when the vehicle is moved forward or backward, the target, camera, or sensor rotates about the shaft to maintain a same orientation (e.g., a same orientation with respect to gravity or a vertical or horizontal reference). An angular measurement sensor attached to the shaft measures the angle of rotation of the wheel with respect to the target, camera, or sensor as the vehicle wheel is rotated when the vehicle moves from the first position to the second position. The presence of a rotation shaft, bearings, and other moving parts inside the wheel alignment heads increases cost and sensitivity to drops, and can add error into alignment measurements (e.g., as a result of stickiness in the bearings).

In visual aligners, alignment heads generally contain no moving parts or sensitive components. Instead, targets forming part of passive alignment heads are fixedly attached to the wheels of the vehicle, and positions of the targets are measured by alignment cameras located off the vehicle. Generally, the alignment cameras are installed at precisely calibrated positions on an external rig (e.g., including the aforementioned solid beam) that is attached to the floor, console, lift, or rack. This makes the existing vision based aligners more expensive, harder to move (e.g., between racks in a vehicle repair shop), and requires an unobstructed visual path between the cameras on the external rig and the targets mounted on the vehicle wheels.

To address the above-noted drawbacks in vehicle wheel alignment systems, a fixed active-head wheel alignment system includes a wheel alignment measuring head that can be fixedly attached to the vehicle wheels and that does not include a rotation shaft and bearings. In the fixed active-head wheel alignment system, the alignment measuring heads maintain fixed positions relative to their respective vehicle wheels and rotate when the vehicle wheels are rotated (e.g., when performing a compensation procedure). In the fixed active-head wheel alignment system, all parts of the wheel alignment measuring heads thus remain immobile with respect to the vehicle wheels when the vehicle wheels are rotated.

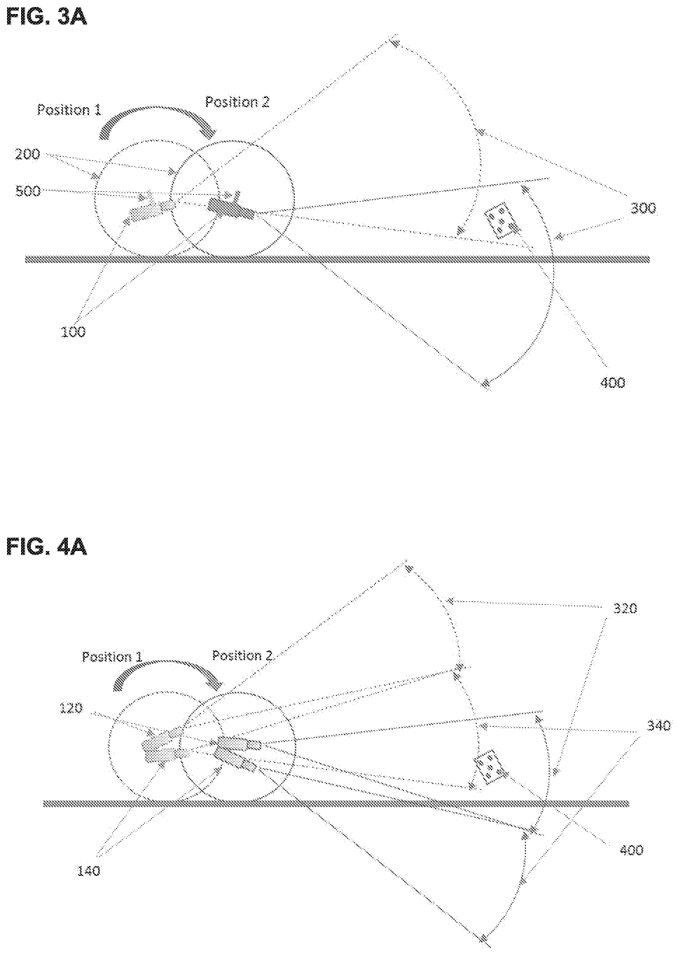

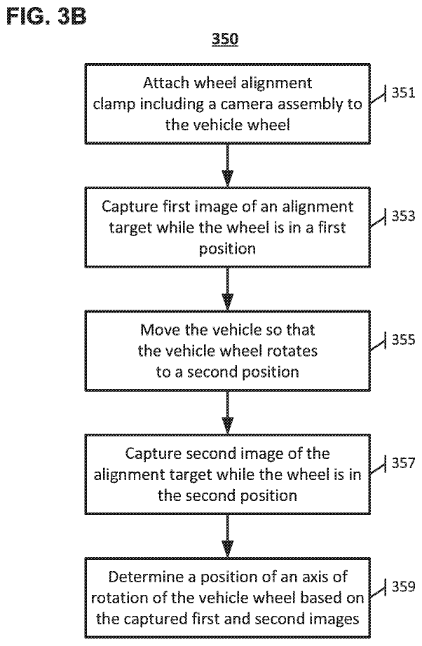

In the fixed active-head wheel alignment system, as illustratively shown in FIG. 3A, an active alignment head including a camera assembly including an alignment camera 100 is rigidly mounted to a vehicle wheel 200 using a wheel clamp 500. The camera assembly including the alignment camera 100 is fixedly attached to the wheel clamp 500 and does not automatically rotate with respect to the wheel clamp 500 when the wheel 200 is rotated (e.g., the alignment camera 100 may instead automatically rotate with the wheel clamp 500 when the wheel 200 is rotated). As a result, when the wheel 200 is rotated from position 1 to position 2 (e.g., when the vehicle is moved between position 1 and position 2), the orientation of the camera assembly and the camera 100 changes as illustratively shown in FIG. 3A. The alignment camera 100 has a sufficiently large field of view (FOV) 300, for example about 30 degrees or more, in one direction such that a fixed reference target 400 (e.g., mounted to ground or other fixed reference surface) and/or a wheel-mounted target (e.g., mounted in a passive alignment head) remains within the FOV 300 as the wheel 200 is rotated from position 1 to position 2 during the compensation procedure, as shown in FIG. 3A. Note that the roll angle of the wheel 200 is typically around 20.degree. (range: 15.degree.-30.degree.), and that the FOV 300 is sufficiently large to enable the alignment camera 100 to maintain the fixed reference target 400 and/or a wheel-mounted target within the FOV 300 as the wheel 200 is rotated approximately 20.degree. (e.g., up to 30.degree.).

In operation, the fixed active-head wheel alignment system can be used to perform an alignment procedure 350 such as that described in relation to FIG. 3B. The procedure or method 350 begins in step 351 with a wheel alignment clamp being attached to the wheel of the vehicle. The wheel alignment clamp can be a fixed active-head that includes a camera assembly attached to a clamp mechanism configured to fixedly attach the wheel alignment clamp to the wheel of the vehicle. The camera assembly includes alignment camera 100. In turn, the alignment camera 100 captures a first image including the fixed target 400 when the wheel 200 is in position 1, in step 353. Following the capturing of the first image, the vehicle is moved such that the vehicle wheel rotates to a second position different from the first position, in step 355. The alignment camera 100 then captures a second image including the target 400 when the wheel 200 is in position 2, in step 357. A processor connected to the alignment camera 100 then determines the position and orientation of the axis of rotation of the wheel 200 from the positions of the fixed target 400 in the first and second images (as the camera has rotated about the axis of rotation of the wheel 200 between the two images) in step 359. Specifically, the processor performs image processing of the first and second images to identify the location and position of the fixed target in the first and second images, and computes the position and orientation of the axis of rotation by determining the movement of the alignment camera 100 having given rise to the change in the position of the fixed target between the first and second images.

Note that in visual aligners, the axis of rotation of a wheel is determined by placing a target on the wheel and capturing images of the rotating target using a fixed camera. In contrast, in the present case, the axis of rotation of the wheel whose position and orientation are determined is the axis of rotation of the camera itself, which corresponds to the axis of rotation of the wheel 200 on which the camera 100 is fixedly mounted. The position and orientation of the axis of rotation is determined in a coordinate system of the fixed target 400 (e.g., a fixed coordinate system that does not move as the wheel 200 and vehicle are moved between positions 1 and 2).

The mathematical description of the axis of rotation calculation for a rotating camera is as follows. There are two different calculation scenarios: (1) the axis of rotation for a camera that is rigidly attached to a wheel while observing a stationary reference target, and (2) the axis of rotation for a target that is rigidly attached to a wheel while being observed by a camera that is also rotating.

For the first scenario, in which the camera rotates while observing a stationary reference target:

V₁=V₀₁V₀

Equation 3: Rotation of Alignment Camera 100 with Respect to a Fixed Reference Target 400 From an Initial to a Second Position

In Equation 3, V₀ is the 3D rotation from a Fixed Reference Target Coordinate System 400 to an Alignment Camera Coordinate System 100 at the initial position, V₁ is the 3D rotation from a Fixed Reference Target Coordinate System 400 to an Alignment Camera Coordinate System 100 at the second position, and V₀₁ is the 3D rotation of the Alignment Camera Coordinate System 100 from the initial to the second position.

The following calculation can be performed to compute V₀₁:

V₀₁=V₁V₀⁻¹

Equation 4: Computation of Composite 3D Rotation between Initial and Second Orientations of the Alignment Camera Coordinate System 100

The axis of rotation u is the principal axis about which all rotation occurs. It can be computed as the principal eigenvector of the rotation matrix V.sub.01 that rotates from an initial to a second orientation:

û=eig(V₀₁)

### Equation 5: Computation of Axis of Rotation of an Alignment Camera Coordinate System Rotating Between Two Orientations

In Equation 5, eig(V₀₁) denotes the eigenvector/eigenvalue decomposition applied to the rotation matrix V₀₁. This eigen-decomposition can be computed in variety of different standard methods, including but not limited to: characteristic polynomial root methods, QR decompositions, power iteration methods, and Rayleigh quotient iterations. u is the eigenvector corresponding to the largest individual eigenvalue computed in the eigen-decomposition.

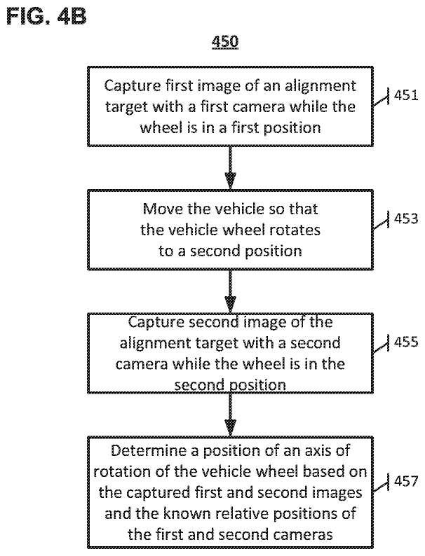

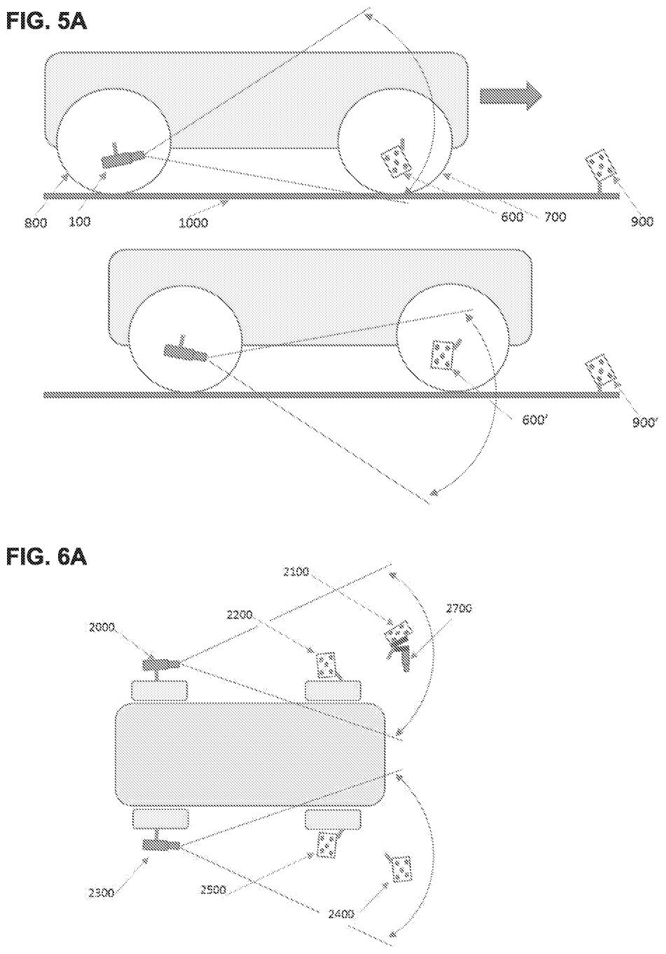

The processing chain is similar for the scenario of a target that is rigidly attached to a wheel that is observed by a camera that is also rotating (see, e.g., FIG. 5A). In this example, a camera 100 forming part of an active alignment head is mounted to a first wheel 800 that is subject to rotation, a wheel mounted target 600 forming part of a passive alignment head is mounted a second wheel 700 that is subject to rotation, and a reference target 900 has a fixed position (e.g., mounted to ground or other fixed reference frame), as shown in FIG. 5A. As in the previous axis of rotation scenario, let U₀ and U₁ be the three dimensional orientations of a fixed reference target coordinate system (e.g., coordinate system tied to the fixed reference target 900) as viewed from the rotating camera coordinate system in two different positions. Let W₀ and W₁ be the three dimensional orientations of a rotating and translating target coordinate system measured with respect to the same reference camera coordinate system that views the fixed reference targets. In this scenario, the camera coordinate system exhibits a rigid body transformation while the wheel mounted target coordinate system also exhibits a rigid body transformation (though not necessarily the same transformation). The reference target 900 does not experience a rigid body transformation. As the reference target maintains a fixed pose while the camera and wheel mounted targets are rotated and translated, it can serve as a reference coordinate system in which the axis of rotation can be computed for the rotating wheel mounted target. In such a scenario, the transformation from the camera coordinate system to the reference target coordinate system can be employed. The three dimensional orientations of the wheel mounted targets with respect to the fixed reference target at position 0 and position 1 can be computed as:

P₀=W₀U₀⁻¹

Equation 6: 3D Orientation of a Wheel Mounted Target Coordinate System with Respect to a Fixed Reference Target Coordinate System at the Initial Position

In Equation 6, U⁻¹₀ is the inverse rotation from the Alignment Camera Coordinate System to the Fixed Reference Target Coordinate System at the initial position; that is, it is the rotation from the Fixed Reference Target Coordinate System to the Alignment Camera Coordinate System at the initial position, W₀ is the rotation from the Alignment Camera Coordinate System to the Wheel Mounted Target Coordinate System at the initial position, and P₀ is the rotation from the Fixed Reference Target Coordinate System to the Wheel Mounted Target Coordinate System at the initial position.

Likewise, a similar formula can be used to compute the orientation of the Wheel Mounted Target Coordinate system with respect to the Fixed Reference Coordinate System at the second position:

P₁=W₁U₁⁻¹

Equation 7: 3D Orientation of a Wheel Mounted Target Coordinate System with Respect to a Fixed Reference Target Coordinate System at the Second Position

In Equation 7, U⁻¹₁ is the inverse rotation from the Alignment Camera Coordinate System to the Fixed Reference Target Coordinate System at the second position; that is, it is the rotation from the Fixed Reference Target Coordinate System to the Alignment Camera Coordinate System at the second position, W₁ is the rotation from the Alignment Camera Coordinate System to the Wheel Mounted Target Coordinate System at the second position, and P₁ is the rotation from the Fixed Reference Target Coordinate System to the Wheel Mounted Target Coordinate System at the second position.

The rotation matrix P₀₁ that rotates the Wheel Mounted target Coordinate System axes from P₀ to P₁ can be computed as:

P₀₁=P₁P₀⁻¹

Equation 8: 3D Rotation of the Wheel Mounted Target Coordinate System from the Initial to the Second Orientation

The axis of rotation w defines the three-dimensional vector about which all rotation is performed. As in the previous scenario, it can be computed as:

ŵ=eig(P₀₁)

### Equation 9: Computation of Axis of Rotation of a Wheel Mounted Target Coordinate System Rotating Between Two Orientations

In Equation 9, eig(P₀₁) denotes the eigenvector/eigenvalue decomposition applied to P₀₁. This eigen-decomposition can be computed in variety of different standard methods, including but not limited to: characteristic polynomial root methods, QR decompositions, power iteration methods, and Rayleigh quotient iterations, and w is defined to be the principal eigenvector corresponding to the largest individual eigenvalue.

Because the fixed target 400 takes up some of the FOV 300 of the camera 100 (see, e.g., FIG. 3A), and because the roll angle of the wheel 200 increases the FOV 300 needed to view the fixed target 400 at both positions 1 and 2, the camera 100 may need to have a very large FOV 300 in order to capture the appropriate images of the target 400 as detailed above. Typically, cameras are faced with a design trade-off between the FOV and the camera's imaging resolution: a larger FOV can be obtained at the cost of a lower resolution. Thus, in order to obtain a large FOV, a camera may have a lower resolution. In the present case, however, the alignment camera 100 must have a high resolution in order to be used for high precision wheel alignment procedures. Thus, merely increasing the camera's FOV at the expense of lowered resolution is typically not desirable. Instead, in order to provide a wide FOV 300 while maintaining a high resolution, an alternative solution is presented in FIG. 4A.

In FIG. 4A, a camera assembly including two (or more) alignment cameras 120 and 140 forming part of an active alignment head is rigidly mounted to a same wheel clamp. Specifically, the active alignment head includes a clamp mechanism configured to fixedly attach the alignment head to a vehicle wheel, and a camera assembly including two cameras is rigidly attached to the clamp mechanism. The two alignment cameras 120 and 140 in the camera assembly are mounted fixedly relative to each other so as to have an angular separation in the direction of the wheel roll. For example, the alignment cameras 120 and 140 may be mounted such that their central axes (extending in a center of each camera's FOV) form a non-zero angle. The camera assembly including cameras 120 and 140 is attached to the wheel to be measured using a wheel clamp (e.g., 500 of FIG. 3A). In the assembly, each camera 120 and 140 need not have a large FOV, but can instead have a smaller FOV 320 and 340 respectively. However, the camera assembly including the two (or more) cameras 120 and 140 has a large combined FOV formed by a combination of the smaller FOVs 320 and 340. During an alignment procedure, so long as at least one of the cameras 120 and 140 can image the target (e.g., fixed target 400) when the wheel is in position 1, and so long as the same one or another one of cameras 120 and 40 can image the target when the wheel is in position 2, a wheel alignment measurement can be determined.

For example, in the example of FIG. 4A, the fixed target 400 is only in the FOV 340 for the lower camera 140 when the wheel is in position 1, and the fixed target 400 is only in the FOV 320 of the upper camera 120 when the wheel is in position 2. Hence, even though the wheel is rolled through the same angle between positions 1 and 2 in each of FIGS. 3A and 4A, the cameras 120 and 140 (which have smaller FOVs 320 and 340 than the FOV 300 of camera 100) can be used since they are mounted as a pair.

In operation, as shown in the procedure 450 shown in FIG. 4B, a first image of the alignment target 400 is captured using the first camera 140 while the vehicle and wheel of the vehicle are in position 1, in step 451. Following the capturing of the first image, the vehicle is moved such that the vehicle wheel rotates to a second position different from the first position, in step 453. A second image of the alignment target 400 is then captured using the second camera 120 while the vehicle and wheel of the vehicle are in position 2, in step 455. The position of the axis of rotation of the vehicle wheel having the camera assembly (including cameras 120 and 140) attached thereto is determined based on the captured first and second images of the alignment target 400 and a known position of the first camera relative to the second camera, in step 457.

Note that once the relative position of the cameras 120 and 140 is fixed, a calibration procedure is performed to precisely determine the relative positions of the cameras relative to each other. Knowledge of the relative positions of the cameras is then used to determine the relative positions of targets imaged by one camera in the other camera's coordinate system. In examples in which the FOVs 320 and 340 of the cameras 120 and 140 overlap, the calibration can be performed by capturing an image of a target positioned in the overlap region of the FOVs with each camera and, based on the captured image, determining the relative positions of the cameras.

A process for transforming one camera's coordinates into the other can involve the following equation:

Tᵤ=Tₗᵤ(T₁)

Equation 10: Transformation of a Target Coordinate System 400 from the Lower Camera Coordinate System 140 to the Upper Camera Coordinate System 120

In Equation 10, T₁ is the pose of a Target Coordinate System 400 in the Lower Camera Coordinate System 140, Tᵤ is the pose of a Target Coordinate System 400 in the Upper Camera Coordinate System 120, and Tₗᵤ is the 3D rigid body transformation from the Lower Camera Coordinate System 140 to the Upper Camera Coordinate System 120.

In examples in which the FOVs 320 and 340 of the cameras 120 and 140 do not overlap (e.g., so as to obtain a wider total FOV), the relative positions of the cameras can be determined using, for example, the first and second targets 200 and 210 described above. In such examples, one target (e.g., 200) is imaged with one camera (e.g., 120) while the other target (e.g., 210) is imaged using the other camera (e.g., 140), and the relative positions of the cameras 120 and 140 is determined based on the captured images of the targets 200 and 210 and the known relative positions of the targets 200 and 210.

FIG. 5A shows an implementation example in which a wheel alignment is being performed on a vehicle using both the side-to-side reference system and the fixed active-head wheel alignment system.

As shown in FIG. 5A, a passive head including a wheel target 600 is rigidly mounted to the front wheel 700 of the vehicle using a wheel clamp (e.g., 500 of FIG. 3A). An active head including an alignment camera 100 is rigidly mounted to the rear wheel 800 of the vehicle using a wheel clamp (e.g., 500 of FIG. 3A). A reference target 900 is rigidly attached to the rolling surface 1000 that the vehicle is supported on with a reference support. The reference target 900 is positioned within the FOV of the alignment camera 100 such that it can be seen by the camera 100.

In operation, as shown in the procedure 550 of FIG. 5B, the alignment camera 100 and wheel target 600 are mounted to respective wheels of the vehicle, and the reference target 900 is attached to a stationary reference, in step 551. In step 553, the alignment camera 100 then captures a first image of both the wheel target 600 and the reference target 900, and the positions of the wheel target 600 and of the reference target 900 with respect to the camera 100 are calculated based on the captured first image. The vehicle is then moved (e.g., moved forward by approximately 8″), as shown in the lower half of FIG. 5A and in step 555. The alignment camera 100 then captures a second image of the wheel target 600 and reference target 900 in step 557, and the positions of the wheel target 600 and of the reference target 900 with respect to the camera 100 are calculated based on the captured second image. The position (and orientation) of the rear wheel's axis of rotation, corresponding to the wheel on which the active head having the alignment camera 100 is mounted, is calculated based on the change in position of the reference target 900 in the first and second images captured at the two camera positions, in step 559. Additionally, also in step 559, the position (and orientation) of the front wheel's axis of rotation, corresponding to the wheel on which the passive head having the alignment target 600 is mounted, is calculated by firstly transforming the front target's position into the reference target's coordinate system at each vehicle position, and secondly calculating the axis of rotation from the change of position of the front target 600 in the reference target coordinate system. Based on these computations, the two wheel axes' positions are determined on one side of the vehicle. A similar process can be performed on the other side of the vehicle to determine the two wheel axes' positions on the other side of the vehicle.

In the foregoing description, the camera 100 is described as being attached to a rear wheel and the target 600 is described as being attached to a front wheel of the vehicle. However, the target could be attached to the rear wheel and the camera to the front wheel. Alternatively, the reference target 600 could be attached to a rack, floor, tripod, or other type of attachment, for example in situations in which only one wheel's axis of rotation is to be determined (e.g., the axis of rotation of the wheel on which the alignment camera is mounted).

The description of FIG. 5A is focused on measurements performed on one side of the vehicle. FIG. 6A provides additional detail on measurements performed on both sides of the vehicle.

For a four wheel alignment, a second set of an alignment camera and targets can be mounted on the other side of the vehicle, as shown in FIG. 6A. As the reference targets (e.g., 900), the side-to-side reference 100 described above in relation to FIGS. 1A and 2A can be used. As shown in FIG. 6A, the left wheel active head including the alignment camera 2000 captures an image of the left reference target 2100 of the active reference pod and the left wheel target 2200, the right wheel active head including the alignment camera 2300 captures an image of the right reference target 2400 of the passive reference pod and the right wheel target 2500. The calibration camera 2700 of the active reference pod captures an image of the right reference target 2400 of the passive reference pod across a width of the vehicle. Using the previously calibrated or known relative position of the calibration camera 2700 to the reference target 2100 of the active reference pod, the relative positions of the active and passive reference pods (and of the two reference targets 2100 and 2400 thereof) are determined. In turn, the coordinate reference frame of measurements established based on the images captured by the right camera 2300 can be transformed into the coordinate reference frame associated with the measurements established based on the images captured by the left camera 2000, based on the determined relative positions of the active and passive reference pods and reference targets 2100 and 2400.

In operation, as shown in the procedure 650 of FIG. 6B, the side-to-side reference is mounted such that reference target 2100 of the active reference pod is visible to the active alignment head (and alignment camera 2000) on one side of vehicle, and the calibration camera 2700 of the active reference pod sees the reference target 2400 of the passive reference pod on the other side of vehicle (step 651). In step 653, alignment images are captured using both of the alignment cameras 2000 and 2300 of the active alignment heads at one or both of the first and second positions of the vehicle. For example, the steps 551-557 of method 550 may be performed using the alignment cameras and targets mounted on each side of the vehicle to obtain first, second, third, and fourth images. Alternatively, just two images may be captured: image data including a perspective representation of the targets 2200 and 210 of the first passive head and of the active reference pod may be captured using an image sensor 2000 of a first active head mounted in association with the first side of the vehicle, while image data including a perspective representation of the targets 2500 and 2400 of the second passive head and of the passive reference pod may be captured using an image sensor 2300 of a second active head mounted in association with the second side of the vehicle. Additionally, a further image of the reference target 2400 of the passive reference pod on the other side of the vehicle is captured using the calibration camera 2700 of the active reference pod, in step 655. Finally, one or more wheel alignment measurements of the vehicle, including wheel alignment measurements of some or all wheels, are determined in step 657 based on the captured images and based on a spatial relationship between the active reference pod and the passive reference pod determined according to the image data produced by the reference image sensor. For example, the spatial relationship between the active reference pod and the passive reference pod can be determined based on the image data produced by the reference image sensor 2700 and including the perspective representation of the passive reference pod 2400, and based on a known spatial relationship between the reference image sensor or calibration camera 2700 and the reference target 2100 attached thereto in the active reference pod.

Specifically, the positions of the passive reference pod (including the right reference target 2400) and the right passive head (including wheel target 2500) are firstly determined from the image(s) captured by the right alignment camera 2300 in a coordinate system centered on the right alignment camera 2300; the determined positions are then transformed into coordinates centered on the passive reference pod and first reference target 2400; the transformed coordinates are then once again transformed into coordinates centered on the active reference pod and second reference target 2100 based on the determined relative positions of the active and passive reference pods and reference targets 2100 and 2400; and finally, the transformed coordinates are further transformed into coordinates centered on the left active head including alignment camera 2000.

A process for transforming coordinates from camera to target to target to camera can involve the following equation:

T_{lcam_rref}=T_{calcam_rref}(T_{iref_calcam}(T_{lcam_lref}))

Equation 11: Transformation from Left Camera Coordinate System 2000 to the Right Reference Target Coordinate System

In Equation 11, T_{lcam_lref} is the 3D rigid body transformation from the Left Camera Coordinate system 2000 to the Left Reference Target Coordinate System 2100, T_{lref_calcam} is the 3D rigid body transformation from the Left Reference Target Coordinate system 2700 to the Calibration Camera Coordinate System 2700, T_{calcam_rref} is the 3D rigid body transformation from the Calibration Camera Coordinate System 2700 to the Right Reference Target Coordinate System 2400, and T_{lcam_rref} is the 3D rigid body transformation from the Left Camera Coordinate system 2000 to the Right Reference Target Coordinate System 2400.

The transformation expressed in Equation 11 can be used to perform the coordinate transformation from the right wheel target 2500 to the left camera coordinate system 2000:

T_{lcam_rw}=T_{rcam_rw}(T_{rcam_rref}⁻¹)(T_{lcam_rref}))

Equation 12: Transformation from Left Camera Coordinate System 2000 to Right Wheel Target Coordinate System 2500

In Equation 12, T_{lcam_rref} is the 3D rigid body transformation from the Left Camera Coordinate System 2000 to the Right Reference Target Coordinate System 2400 (as computed in Equation 11 above), T⁻¹_{rcam_rref} is the inverse of the 3D rigid body transformation from the Right Camera Coordinate System 2300 to the Right Reference Target Coordinate System 2500. I.e. it is the 3D rigid body transformation from the Right Reference Target Coordinate System to the Right Camera Coordinate System, T_{rcam_rw} is the 3D rigid body transformation from the Right Camera Coordinate System 2300 to the Right Wheel Target Coordinate System 2500, and T_{lcam_rw} is the 3D rigid body transformation from the Left Camera Coordinate System 2000 to the Right Wheel Target Coordinate System 2500.

Based on the determined relative positions of the various alignment heads and reference pods (including the various cameras and targets), both active alignment heads (including cameras 2000 and 2300) are thus able to measure positions of targets and transform the measured positions into the same coordinate system. Thus, the full vehicle alignment can be measured, for example by projecting the wheels axis in the vehicle base plane. The positions of targets measured using the left camera can be transformed into a coordinate system centered on the right camera in a similar manner. Alternatively, positions (and coordinates) can be transformed into a reference frame centered on one of the reference targets (e.g., 2100). In any case, since a common coordinate system is used, the alignment of all wheels can be measured.

In the examples of FIGS. 5A and 6A, it is also possible to use active alignment heads and camera assemblies including two or more cameras—such as those described above in relation to FIG. 4A. Such camera assemblies can be used in situations in which a wider FOV is needed. Additionally, in the example of FIG. 6A, the passive reference pod including the right reference target 2400 could include dual targets such as the passive reference pod 110 discussed in relation to FIG. 2A above. Also, while the active reference pod including the calibration camera 2700 is described as being on the left side of the vehicle, the active reference pod and calibration camera 2700 can alternatively be on the right side of the vehicle (e.g., attached to the reference target 2400, and looking across to the passive reference pod including the left reference target 2100).

In the various examples presented above, the reference targets (e.g., 400, 900, 900′, 2100, 2400) are positioned so as to be in the FOV of a corresponding alignment camera. In some examples, the alignment camera is positioned so as to also concurrently include an alignment target (e.g., 600, 600′, 2200, 2500) in its FOV. In order to position the reference targets at positions that are both in the FOV of the alignment camera and not occluded by the alignment targets in the FOV, the reference targets may be attached to the surface 1000 on which the vehicle is sitting (e.g., attached to the rack or vehicle lift, attached to the ground, or the like). In particular, the reference targets may be positioned so as to be in a consistent relative position with the alignment targets mounted to the wheels, but also positioned such that the reference target move with the vehicle (e.g., should the vehicle be positioned on a rack or vehicle lift and the rack or vehicle lift is raised).

In the foregoing description and figures, the active and passive reference pods are described and shown as being optionally mounted with passive alignment heads to wheels of the vehicle being measured (see, e.g., FIGS. 1B and 2B) or to a fixed or stationary reference (e.g., ground, a rack or lift, or the like) (see, e.g., FIG. 6A). As described, the wheel alignment systems incorporating the active and passive reference pods are configured to measure alignment values of a vehicle in both mounting situations.

Additionally, while the foregoing description and figures have described and shown active alignment heads including the cameras (or image sensors) as being mounted to wheels of the vehicle, the active alignment heads can alternatively be mounted to a fixed or stationary reference (e.g., ground, a rack or lift, or the like). For example, FIG. 6C shows an alignment system 670 in which the active heads are mounted to a stationary reference such that that the image sensors (e.g., alignment cameras 105a and 105b) remain stationary throughout the alignment process even if the vehicle moves. The active heads included in the alignment cameras (105a and 105b) can be mounted to ground (e.g., using a tripod, a wall structure, or the like) such that they remain immobile even if the vehicle is lifted on a lift, or the active heads can be mounted to a vehicle lift or rack such that they are raised or lowered with the vehicle when the vehicle is lifted and lowered. In such examples, the active alignment heads are nonetheless mounted in association with opposite sides of the vehicle such that one active alignment head can image targets located on one side of the vehicle while the other active alignment head can image targets located on the opposing side of the vehicle.

In the example of FIG. 6C, the active and passive reference pods are also mounted to a fixed or stationary reference (e.g., ground, a rack or lift, or the like), although they could alternatively be mounted to the vehicle (e.g., as shown in FIGS. 1B and 2B). Additionally, in order for the alignment system 670 to measure alignment of all four wheels of the vehicle, passive alignment heads (each including a target) are provided on all four wheels of the vehicle to be imaged by the cameras 105a and 105b of the stationary-mounted active alignment heads.

Various options exist for mounting the active or passive reference pods or other reference target(s) to the rack, vehicle lift or the like. A first option, of bolting a hanger bracket on the rack, may require drilling into the rack which may compromise the structural integrity of the rack and may in some situations not be possible. Furthermore, drilling into the rack makes for a time consuming installation process. For these reasons, this first option may not be preferred. Ideally, the active or passive reference pods or other reference targets would be removably attached to the rack or slidable so that the reference pods or targets can be moved out of the way when not in use. For this purpose, a second quick attachment method to the rack may be preferred. Further an attachment that can enable easy attachment of the reference pods or targets may be preferred, and that can allow the reference pods or target to be moved out of the way while remaining attached to the rack.

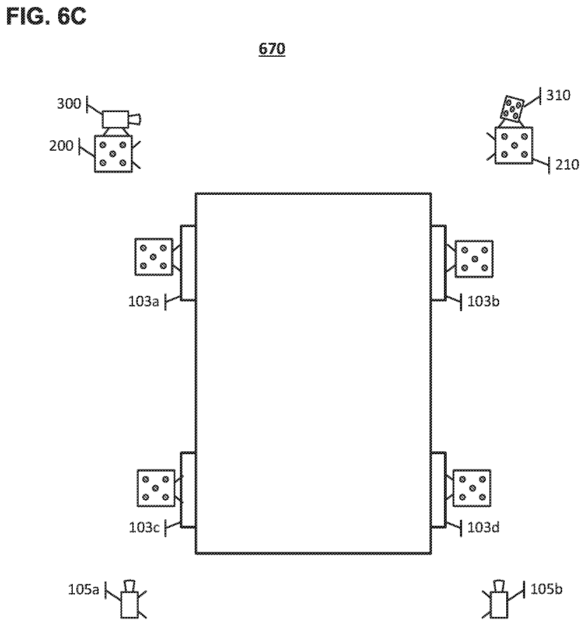

To provide the above-identified advantages, a mount is shown in FIG. 7. The mount is used to attach the reference pod or target 5500 to the rack 5100 or lift (e.g., vehicle lift). The mount includes a course width adjustment 5200 that enables a width of the mount to be adjusted so that the mount can be used on and securely mounted to racks of various sizes. Additionally, a fine adjustment 5300 latches to a side of the rack surface and is used to secure or clamp the mount to the rack. Further, a slide portion 5400 enables the reference pod or target 5500 (and/or an arm holding the reference pod or target 5500) to be slid inward and outward of the rack 5100, such that the reference pod or target 5500 can be positioned outward (into the FOV of an alignment camera or other image sensor) during an alignment process and readily slid inward afterwards in order to be out of the way and not interfere with further operations once the alignment is completed. In some situations, the reference pod or target 5500 is slid laterally outwards along the slide portion 5400 such that the reference pod or target 5500 is located laterally outwards from any wheel-mounted targets so as to ensure that the reference pod or target 5500 is not occluded by any wheel-mounted target during an alignment procedure.

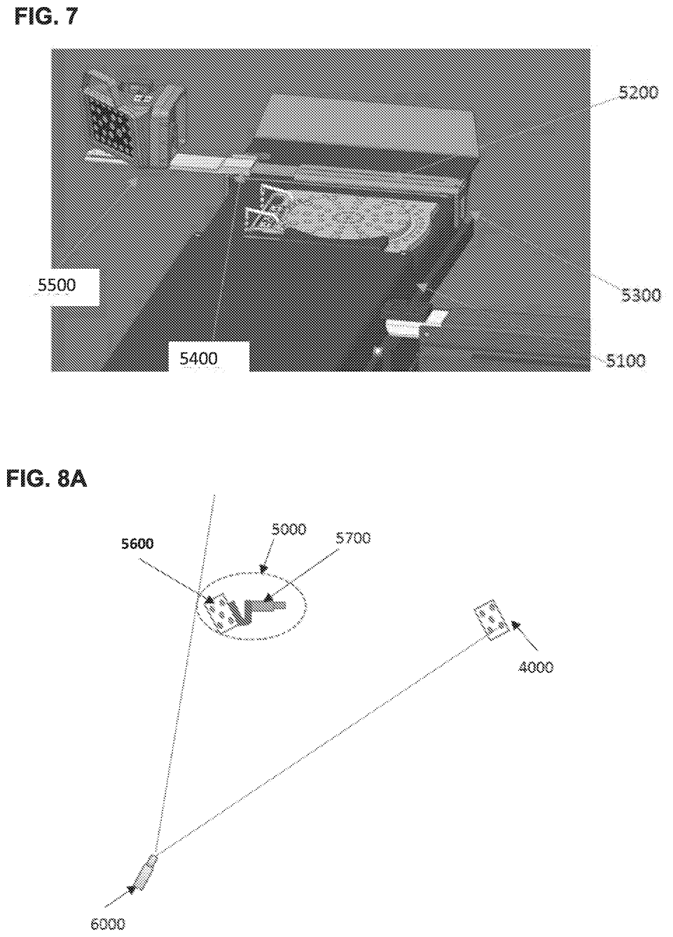

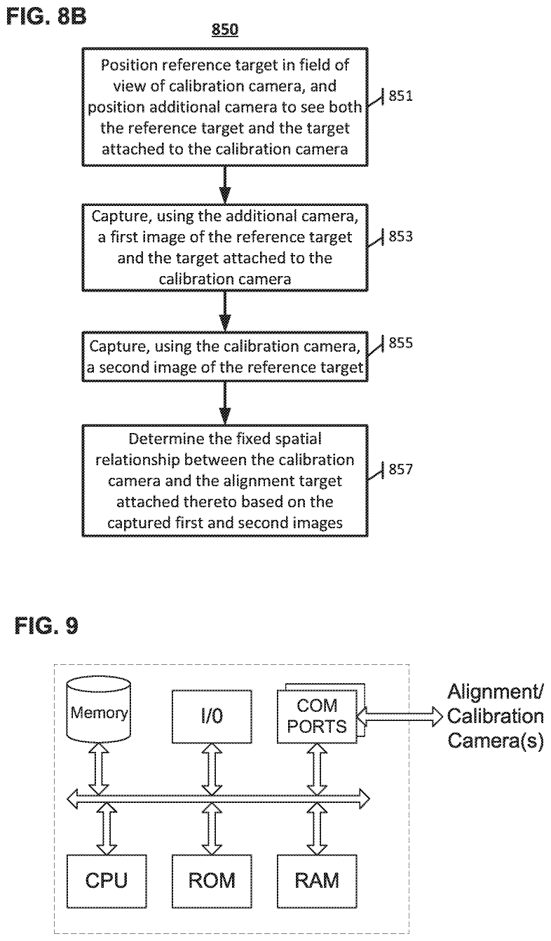

As noted above, the use of the side-to-side reference discussed in relation to FIGS. 1A-1B, 2A-B, and 6A-6C relies on the positional relationship between the reference target 200 and calibration camera 300 of the active reference pod to be known. The positional relationship may be set during manufacture of the side-to-side reference, and may be known based on the manufacturing specifications of the apparatus. Alternatively, the positional relationship may be adjustable or variable. In both cases, a calibration process, described below in relation to FIGS. 8A and 8B, may be used in order to measure the relative position for use during alignment processes.

The calibration process may be performed following manufacturing in the factory, or can be performed in the field (for example following the replacement of a part of the side-to-side reference, following possible damage to the side-to-side reference, or simply to confirm that the factory specifications are still accurate).

To perform the calibration, the procedure 850 shown in FIG. 8B can be used. In step 851, the second reference target 4000 and the active reference pod 5000 (including first reference target 5600 and the calibration camera 5700 fixedly attached thereto) are positioned relative to each other such that the calibration camera 5700 can capture an image of and measure the position of the reference target 4000 relative to the calibration camera 5700. Additionally, an additional camera 6000 is positioned such that both the first and second reference targets 5600 and 4000 are within its FOV. The additional camera 6000 can then capture an image of both reference targets 5600 and 4000, and establish the positions of the reference targets 5600 and 4000 relative to the camera 6000.

Once the cameras and targets are in position, the camera 6000 captures a first image of first reference target 5600 and second reference target 4000 so as to measure the pose of first reference target 5600 and second reference target 4000, in step 853. The measured pose is used to calculate a rotational matrix from reference target 4000 to reference target 5600. Additionally, in step 855, the calibration camera 5700 captures a second image of the reference target 4000 so as to measure the pose of reference target 4000 with respect to the calibration camera 5700. With the rotation matrix of the reference target 4000 to the reference target 5600, and with the pose of reference target 4000 with respect to the calibration camera 5700, a rotation matrix relating measurements from the reference target 5600 to the calibration camera 5700 is determined. In this way, the fixed spatial relationship between the calibration camera 5700 and the alignment target 5600 attached thereto can be determined based on the captured first and second images. The rotational matrix can then be used to update the relative positions (rotation matrix) between the two reference targets 5600 and 4000 every time the calibration camera 5700 measures the pose of the reference target 4000, as during an alignment procedure.

In order to effect the appropriate coordinate transformations, two different coordinate transformations can be used: an “RTTP” which, in combination with a transformation of target coordinates into calibration camera coordinates can provide an “RCTP” result.

The transformation from a second to a first reference target can be computed as:

T_{ref2_ref1}=T_{refcam_ref1}(T_{refcam_ref2}⁻¹)

Equation 13: 3D Rigid Body Transformation from Second Reference Target Coordinate System 4000 to First Reference Target Coordinate System 5600

In Equation 13, T⁻¹_{refcam_ref2} is the inverse of the 3D rigid body transformation from the reference camera coordinate system 6000 to the second reference target coordinate system 4000; that is, it is the transformation from the second reference target coordinate system to the reference camera coordinate system, T_{refcam_ref1} is the 3D rigid body transformation from the reference camera coordinate system 6000 to the first reference target coordinate system 5600, and T_{ref2_ref1} is the 3D rigid body transformation from the second reference target coordinate system 4000 to the first reference target coordinate system 5600.

The transformation from the second to the first reference target can be used (in conjunction with additional information) to compute the transformation from the first reference target 5600 to the calibration camera 5700. This process can be computed as:

T_{ref1_calcam}=T_{ref2_ref1}(T_{calcam_ref2})

Equation 14: 3D Rigid Body Transformation from First Reference Target Coordinate System 5600 to Calibration Camera Coordinate System 5700

In Equation 14, T_{calcam_ref2} is the 3D rigid body transformation from the calibration camera coordinate system 5700 to the second reference target coordinate system 4000, T_{ref2_ref1} is the 3D rigid body transformation from the second reference target coordinate system 4000 to the first reference target coordinate system 5600 (as computed previously in Equation 13), and T_{ref1_calcam} is the 3D rigid body transformation from the first reference target coordinate system 5600 to the calibration camera coordinate system 5700.

### Application of “Drive Direction” Principle of Operation to Wheel Aligner

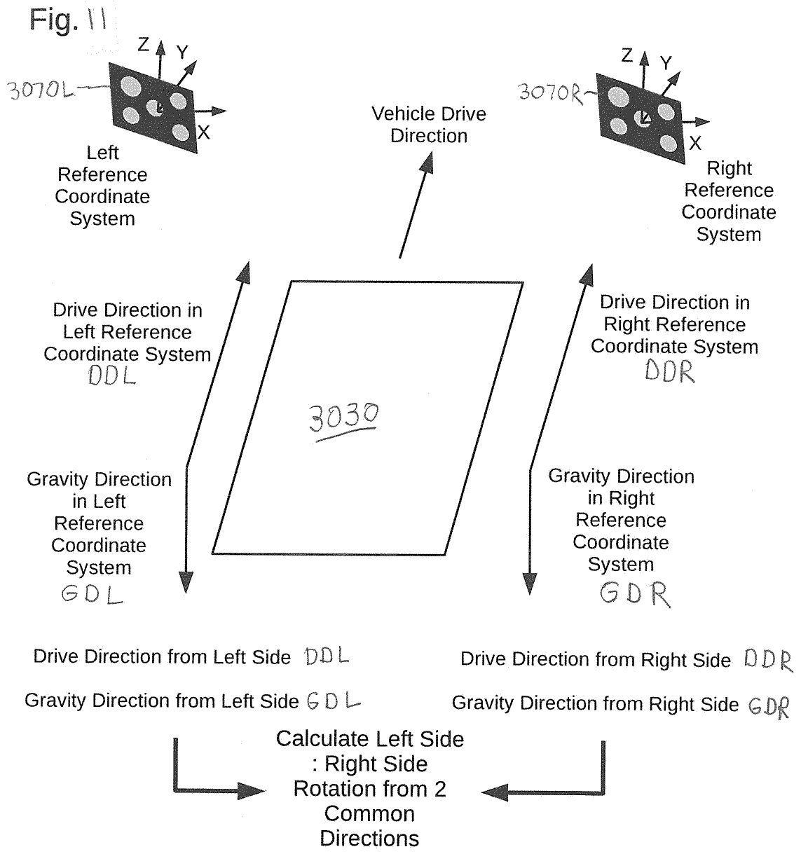

In this section, an alternative embodiment of the wheel aligner is described. In this alternative embodiment, depicted in FIG. 10, the calibration camera 2700 rigidly attached to the left reference target coordinate system of the aligner of the embodiment of FIG. 6A is removed. There is no direct measurement across the lateral dimension of the vehicle. In this embodiment, as in others described herein, there are reference targets 3070L, 3070R rigidly attached to each side of the left and right sides of the alignment lift 3040. Targets 3080L, 3080R of known geometry, also referred to as “passive heads” are rigidly mounted to the left front wheel 3022L and right front wheel 3022R of the vehicle 3030, and measurement pods 3020L, 3020R (also referred to as “active heads”) are rigidly attached to the left rear 3024L and right rear 3024R vehicle wheels. Each measurement pod 3020L, 3020R consists of a calibrated camera 3010L, 3010R and a calibrated inclinometer 3102L, 3102R. With these sensors in each pod 3020L, 3020R, the aligner of this embodiment is able to measure vehicle alignment angles without a direct measurement in the lateral vehicle dimension.

### Drive Direction Principles of Operation

The disclosed alignment systems and methods operate based on a calculation of a parameter called “drive direction,” which is the direction in which a vehicle is moving. Since a vehicle can be assumed to be a rigid body, each wheel (and each axle) has the same drive direction. Consequently, an alignment parameter of one wheel or one axle can be compared to the same parameter of another wheel or axle by equating their drive direction. For example, each axle's toe can be compared to each other axle's toe by equating each axle's drive direction. Therefore, the relative toe of two axles can be measured (i.e., the axle scrub), without all the cameras of a typical visual aligner seeing both axles at the same time, or without wheel position or orientation information from one side of the vehicle to the other.

A basic concept of drive direction alignment is to measure geometric properties of interest for wheel alignment without directly measuring lateral (i.e., “left to right”) position or orientation information about system components. Rather, the disclosed aligners indirectly measure information that couples measurements from left and right sides, allowing measurements from one side of the vehicle to be transformed into a common coordinate system with measurements from the other side of the vehicle. This can be accomplished by measuring two or more directions in common from both sides of the vehicle.

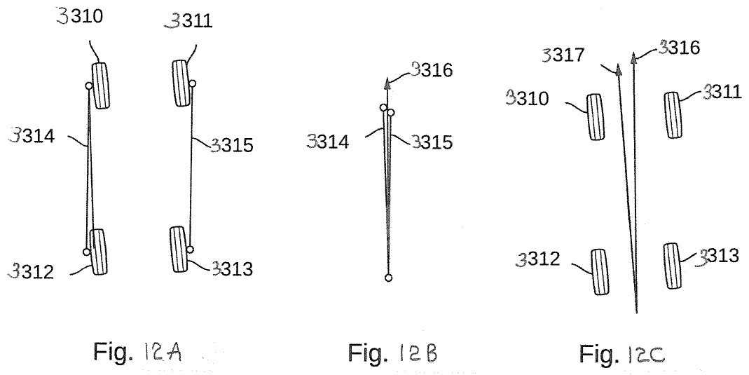

This basic principle will be explained with reference to FIGS. 10 and 11. In the illustrated embodiment, the two common directions measured on both the left and right sides of the vehicle 3030 are the drive direction DDL, DDR and the gravity direction GDL, GDR. Drive direction is measured from a calibrated camera 3010L, 3010R on each side of the vehicle (on each of the rear wheels 3024L, 3024R), and gravity direction is measured from a calibrated inclinometer 3102L, 3102R rigidly coupled to each camera 3010L, 3010R. In other words, inclinometers 3102L, 3102R are each disposed in a known relationship to a respective one of the cameras 3010L, 3010R. The gravity and drive direction measurements are transformed to the left and right reference coordinate systems defined respectively within the left and right reference targets 3070L, 3070R positioned in front of the front vehicle wheels 3022L, 3022R. Alternatively, the inclinometers could be coupled to any stationary target. For example, in certain alternative embodiments, inclinometers 3102L, 3102R are each disposed in a known relationship to a respective one of the reference targets 3070L, 3070R. The transformation of each inclinometer measurement to its coupled camera or target is known from a prior calibration, which is described herein below.

### Measurement of Gravity Direction

In the embodiment depicted in FIGS. 10 and 11, gravity is measured by each inclinometer 3102L, 3102R in the left and right sides of the vehicle 3030. Depending on the type of inclinometer used, those of skill in the art will understand that the measured output may be in the format of a 3D vector expressing the direction of gravity in the inclinometer coordinate system, or it may be expressed as a set of (θX, θY) rotation angles that describe the inclination about the (X, Y) axes of the inclinometer. If the output is a 3D vector describing the gravity vector in the inclinometer coordinate system, it can be directly used in the processing chain.

If the output format is a set of (θX, θY) inclination angles, these angles must be converted to a 3D gravity vector to be used in the processing chain described above. This can be accomplished in a variety of ways. In one embodiment, an initial vector denoting the orientation of gravity in the inclinometer coordinate system is encoded as a 3D vector X=0, Y=0, Z=1. This 3D vector is then made to rotate about the inclinometer X axis by the rotation angle θX. The rotated 3D vector is then rotated about the inclinometer Y axis by the rotation angle θY. This rotated 3D vector now describes the orientation of gravity in the inclinometer coordinate system, given that the inclinometer sits at an inclination of (θX, θY), and can be used in the described processing chain.

The above discussion assumes that a three-dimensional wheel alignment procedure is performed. The present disclosure is not, however, restricted to purely 3D alignments. It may be desirable to perform 2D alignment measurements. In such a scenario, gravity is measured not as a 3D vector or as a set of 2D angles, but as an elevation angle from a single axis sensor. Under such a configuration, it is assumed that all tilt between cameras is in the vehicle camber direction. The measured inclination angles on both sides of the vehicle are then used to adjust the relative left to right tilt angles of cameras on both sides of the vehicle. This relative tilt angle between the sides of the vehicle is then used as an offset to measure camber angles on both sides of the vehicle to a common reference. Deviations of drive direction measurements from both cameras in the camber direction are ignored.

### Transformation of Gravity Directions From Inclinometer to Reference Coordinate System

On both sides of the vehicle 3030 we must express gravity direction and drive direction in a common coordinate system. This means that geometric quantities measured in one coordinate system must be transformed to the same coordinate basis so that they can be used in downstream calculations. In the system depicted in FIGS. 10 and 11, this is accomplished by transforming the measured gravity direction GDL, GDR from each inclinometer coordinate system to its associated reference coordinate system. This transformation is a two-stage process on each side of the vehicle. First, gravity directions must be transformed from the inclinometer coordinate system in which it is initially measured into the camera coordinate system of the camera which is rigidly attached to its inclinometer. The gravity direction must then, using the measurement of the reference target pose in the camera coordinate system, be transformed from the camera coordinate system to the reference coordinate system.

The transformation from the inclinometer coordinate system to the camera coordinate system is a well-known transformation which requires a calibration that quantifies how measurements from the inclinometer coordinate system are transformed to the camera coordinate system. The calibration consists of a 3D rotation from the inclinometer coordinate system to the camera coordinate system (or the inverse). At run-time, the measured 3D gravity vector in each inclinometer coordinate system is rotated by the inclinometer to camera coordinate system rotation calibration. The net effect is that the gravity, measured in the inclinometer coordinate system, is now expressed in the camera coordinate system on each side of the vehicle.

To express gravity direction in the reference coordinate system, an additional transformation is required, from the camera coordinate system to its associated reference coordinate system. The cameras rigidly attached to the rear wheels depicted in FIG. 1 image the reference target coordinate systems. Using standard pose estimation algorithms, the pose of the reference target coordinate system is measured in the respective camera coordinate systems. With this pose measured, measurements expressed in the camera coordinate system can be transformed to the reference target coordinate system. Thus, with knowledge of the pose of the reference target coordinate system in the camera coordinate system, and knowledge of rotation from the inclinometer coordinate system to the camera coordinate system, we can express the gravity direction in its associated reference coordinate system.

### Measurement of Vehicle Drive Direction

In the embodiment depicted in FIGS. 10-11, drive direction DDL, DDR is measured on each side of the vehicle 3030 with respective cameras 3010L, 3010R. Cameras can be used in a variety of ways to measure drive direction, but in the system depicted in FIG. 10 a set of targets 3080L, 3080R are attached to the front vehicle wheels 3022L, 3022R while the cameras 3010L, 3010R are rigidly attached to the rear wheels 3024L, 3024R. In addition, a set of reference targets 3070L, 3070R are rigidly attached to the alignment lift/vehicle rolling surface 3040 in such a pose that they can each be imaged by a respective wheel mounted camera 3010L, 3010R through a sufficient rolling distance and roll angle. The relative pose of the left and right reference targets 3070L, 3070R is not known a priori. The conventional wheel mounted and reference targets each consist of a set of fiducials arranged in a known geometry. The fiducials are identified and localized in a series of camera images as the vehicle rolls through a minimum distance. At each image where the targets are visible, the 3D pose of the wheel targets and reference targets is calculated in each camera coordinate system in a process well-known to those skilled in the art as monocular pose estimation.

At a series of vehicle roll angles, the pose of the reference target coordinate system is measured concurrently with the Wheel target coordinate system. With pose of these two targets measured at the same camera pose, we can transform the pose of the Wheel target coordinate system into the reference target coordinate system. The pose of the camera coordinate system and of the Wheel target coordinate systems are expressed in their respective reference coordinate systems at multiple positions during the course of the vehicle roll.

Upon completion of the rolling motion, the measured 3D locations of the wheel targets and cameras at all positions are used to calculate the vehicle drive direction. To calculate drive direction, target and/or camera positions must be measured in at least two distinct vehicle rolling positions. Depending on the phase angle at which the wheel-mounted targets and/or cameras are mounted on the rolling vehicle, it may be advantageous to perform some orthogonalizations of the measured target/camera coordinates. If target or camera pose measurements are imaged while attached to the frame or body of the vehicle or positioned at the center of their respective wheels, they should travel in a straight line. But if, for example, the targets are positioned on vehicle wheels off-center, they will in general trace out a cycloidal trajectory. For this scenario, the direction of best-fit lines through the target centers will depend on the phase angle of the target on the wheel at the various data acquisition positions. In other words, the target will oscillate with some translation component in directions that are orthogonal to the true vehicle drive direction. This same consideration applies to the location of the camera coordinate systems in their respective reference coordinate systems.

These deviations from the true vehicle drive direction can be subtracted from the measured target locations by reference to external measurements that are approximately orthogonal to vehicle direction. For example, by using the gravity plane or the plane along which the vehicle rolls, the normal of the gravity plane or the rolling plane can be used as a direction to remove the orthogonal component of the target or camera oscillations. This reduces the uncontrolled variability in the measurement of vehicle drive direction, enabling a more accurate and repeatable drive direction measurement.

Once target and/or camera positions have been orthogonalized as described above (if needed), the array of 3D center locations are then used as input to a well-known least squares calculation algorithm. The optimal drive direction is computed using least squares methods to determine the primary direction of target and/or camera motion on each side of the vehicle. The net result of this calculation, carried out independently for the left and right sides, are vehicle drive directions DDL, DDR measured in each of the left and right reference coordinate systems.

It must also be noted that for vehicles with front wheel steer (either because front wheels are turned, or because individual front toe angles are badly out of spec), wheel targets imaged while attached to the front wheels will experience slightly different trajectories. This problem will compound when rolling distances are larger, and the vehicle is made to turn through a larger semi-circle. For shorter rolling distances, the effect of steer angle should however be quite limited.

In the event that vehicle steer is not negligible, the effects of steer can be detected and compensated for in various ways. One method is to calculate the axis of rotation of the wheel mounted targets between successive positions in the rolling motion, and to use the deviation of the wheel axes with wheel roll angle to determine the steer axis and steer angle. With the steer axis and angle, the nonlinear target trajectories can then be corrected for independently on each side of the vehicle, resulting in steer-adjusted drive directions.

### Calculation of Left to Right Side Rotation From Measurement of Common Directions

The problem of determining the optimal rotation between left and right camera coordinate systems is an instance of what is known to those in the art as Wahba's Problem. The basic question of this method is: given two or more directions measured in an initial coordinate system, and those same directions measured in a second coordinate system, what is the optimal rotation between the two coordinate systems? This problem can be solved in various ways. If the number of common directions measured in two coordinate systems is exactly two, the so-called Triad method can be used to solve for the optimal rotation between the two coordinate systems. For two or more measurements in common in both coordinate systems, more general solution methods such as the Kabsch algorithm, Davenport's Q-method, and other computational algorithms, are used to determine the optimal rotation between coordinate systems. The details of the methods vary, but the essence of all such methods is to solve for the rotation that minimizes the least-squares error when rotating from one coordinate system to the other. Most methods incorporate a singular value decomposition of the 3D covariance matrix of the pairs of corresponding 3D vectors.

As depicted in FIG. 11, the two common directions on the left side of the vehicle 3030 are the vehicle drive direction DDL in the left reference coordinate system, and the gravity direction GDL in the left reference coordinate system (originally measured in the left inclinometer coordinate system, but transformed to the left camera coordinate system and then the left reference coordinate system using the previously described coordinate transformation process). The vehicle drive direction DDR and gravity direction GDR are similarly measured in the right reference coordinate system. These pairs of vectors (drive direction left DDL, gravity direction left GDL), and (drive direction right DDR, gravity direction right GDR) are then input to the least squares rotation estimation algorithm, and the 3D rotation that optimally rotates vectors from the left side of the vehicle to the right side (or vice versa) is the output. The 3D rotation can be expressed as a 3×3 rotation matrix, a 3 element vector of Euler angles, a 4 element unit quaternion, or other representation of rotation. The specific format is not material, and the various representations are interchangeable.

### The Need For At Least Two Unique Directions

It must be emphasized that two or more unique common directions are required to calculate a unique 3D rotation between the two coordinate systems. With no common directions between the two coordinate systems, we have no information at all to constrain the rotation between. With only one common direction between both coordinate systems, we do not have enough information to determine a unique rotation between coordinate systems.

It must also be emphasized that the two or more common directions used to determine the optimal rotation between coordinate systems must be unique directions. If the two directions were parallel, they would actually point in the same direction. The more unique the directions, the better. Ideally, the common directions are orthogonal or nearly so. The more orthogonal the directions are to each other, the greater the amount of unique information that is incorporated into the calculation of the optimal left to right rotation solution.

### Alternative Embodiments

The embodiment described above uses cameras 3010L, 3010R and inclinometers 3012L, 3012R to measure vehicle drive direction and gravity direction, respectively. However, the basic principle of correlating two coordinate systems based on measurement of two or more common directions can be extended in various ways.

### Principle of Operation Not Restricted to Vehicle Drive Direction and Gravity Direction

The disclosed “drive direction” aligner uses vehicle drive direction and gravity direction as the common directions to measure on both sides of the vehicle. The core concept of determining the relative left and right sides of the vehicle, however, does not require these two directions. Any two or more common directions can be used to perform alignment measurements in the manner described. One could employ, for example, a magnetometer to use the measured direction to the magnetic north pole as a common direction that will be (for all practical purposes) the same on both sides of the vehicle. Another sensor which could be employed is a gyroscope, where the left side and right side gyroscopes are configured so as to measure a common direction. Still another well-known sensor that could be used is an absolute orientation sensor, which combines the measurements of plural independent sensors (such as an accelerometer, magnetometer, and gyroscope) to measure orientation with respect to an absolute reference direction. Any common direction measuring sensor can be used, provided that its common direction measurements can be transformed into common direction measurements from other sensors on each side of the vehicle. These are just some examples of other ways in which common directions can be measured on both sides of the vehicle.

### Use of More Than Two Common Directions

In the measurement system described, two corresponding directions are measured on both sides of the vehicle to determine the left side to right side transformation. The number of corresponding directions need not be restricted to two, however. Arbitrarily many corresponding directions can be used to determine the left to right orientation. The calculation algorithms employed are not restricted to two common directions, so long as the additional directions in common are not parallel and thus provide complementary information to restrict the optimal solution.

### Use of Only One Common Direction in a Reduced Functionality System

As described, at least two 3D common directions are required to determine a unique 3D rotation between left and right sides of the vehicle. However, it is possible to retain some of the functionality of the system described if only one corresponding direction is measured on left and right sides of the vehicle. For example, it is possible to determine 2D rotations from just one common measured direction. This may be useful, for example, in a scenario wherein wheel alignment measurements are desired in a strictly 2D mode of operation.

### Use of Alternative Gravity Measurement Sensors and Methodologies

As described, measurement of the gravity direction on both sides of the vehicle is performed with a conventional inclinometer. There are various other ways, however, in which gravity direction can be measured without using an inclinometer. Accelerometers could be used in lieu of inclinometers to measure gravity direction. Plumb lines or similar free-hanging masses could also be used to provide a measure of gravity direction. If the cameras themselves can be secured such that they do not rotate with respect to the vehicle rolling surface plane, one can perform a prior calibration step to determine the normal of the rolling surface in each of the left and right camera coordinate systems. This normal direction can then be used to provide a common reference direction for both sides of the vehicle.

### Use of Preexisting Vehicle Feature Points In Lieu of or In Addition to Targets

In the embodiments described herein, targets of a predetermined geometry are fixed to a vehicle and measured with cameras to determine vehicle drive direction. Targets are not required, however, as there are various ways in which 3D drive direction can be determined without reference to them. One example is to use stereo vision techniques. For example, if stereo cameras are used on each side of the vehicle on the rear wheels, and can be positioned such that the surfaces of the front wheel surfaces are visible with sufficient resolution, textured feature points on the front wheel surfaces can be detected and matched in all cameras in each stereo camera array. With the detection and matching of corresponding feature points in the stereo camera array, 3D position measurements of feature points on the wheel surface can be detected and tracked as the vehicle rolls. These feature points can then be used in an analogous manner to a target with a predetermined geometry.

It is possible to use additional techniques other than stereo vision to measure vehicle drive direction without employing a target with a predetermined geometry. One could use structured light projection techniques to determine the 3D position of feature points throughout the vehicle rolling motion, and then used in an analogous manner to a target with a predetermined geometry.

One could also use “structure from motion” techniques to determine the 3D geometry of textured vehicle feature points from a single camera, provided some additional constraints about camera motion. With such techniques, a single camera effectively becomes a stereo camera array.

### Use of “Live” Inclinometer to Camera Calibration

In the embodiment of FIGS. 10-11, the relative transformations between the two sensors of interest (cameras 3010L, 3010R and rigidly coupled inclinometers 3012L, 3012R) are known at the start of the alignment due to a prior calibration process (or processes). The assumption is that the relative pose of the sensors does not change between the relative sensor orientation calibration process and the time at the start of the run-time measurement process. For certain scenarios, however, it may be advantageous to not rigidly couple the camera and inclinometer, at which point the relative sensor orientation must be determined through the course of the alignment process. This distinction (relative sensor orientation performed before or during the alignment process) is not germane to the core novelty of the disclosure.

### Calculation of Alignment Angles

Given the above measurements, calibrations, and intermediate transformations, how does one calculate wheel alignment angles of interest from such a measurement system? Once key equivalences are established, the basic geometric quantities of interest are much the same as in traditional wheel alignment measurement systems that directly measure right side to left side transformations.

### Measurement of Runout Compensation

Runout compensation of the wheel mounted targets is performed in the same manner as prescribed in traditional wheel alignment systems. The concept and calculation of runout is discussed, for example, in U.S. Pat. No. 5,535,522. The core concept is to observe the orientation change of a coordinate system that is rigidly mounted to a vehicle wheel. The orientation change of this coordinate system as the wheel rolls allows for a calculation of the optimal wheel axis of rotation. The only addition to this concept in a “drive direction” aligner is a downstream step in the processing chain where all wheel axes are transformed into a common coordinate system (i.e., from the right side of the vehicle to the left side) using the optimal right side to left side rotation.

### Establishing a Vehicle Coordinate System (VCS)

The notion of a vehicle coordinate system (VCS) is a commonly used concept in wheel alignment. See, for example, U.S. Patent Application Publication 2017/0097229. The VCS serves as a frame of reference in which alignment angles can be expressed. In the prior art, camber angles are commonly defined with respect to the VCS (X, Y) plane, and individual toe angles are commonly defined with respect to the GCL (Geometric Center Line) or the thrust line of the vehicle.

### Calculation of the GCL In a “Drive Direction” Aligner

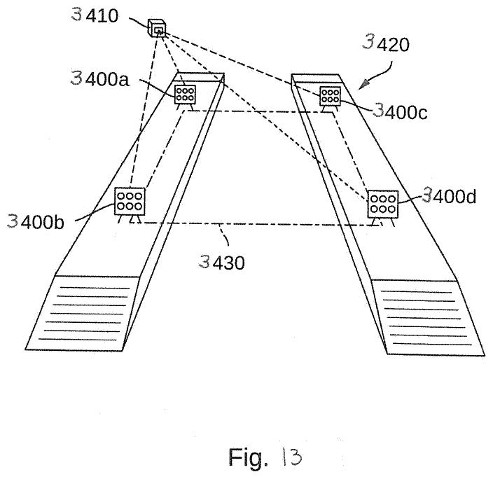

In the prior art, the geometric center line (GCL) is calculated as the direction from the middle of the rear wheels to the middle of the front wheels. This is depicted in FIGS. 12A-12C. In a measurement system which lacks a direct measurement of left to right sides of the vehicle, it may seem impossible to measure GCL. A deeper examination of vehicle geometry shows, however, that it is possible to measure a mathematically equivalent GCL with some additional information about vehicle geometry.

A typical GCL measurement process when direct measurements are made between left and right sides is depicted in FIGS. 12A-12C. With direct left to right measurements of wheel centers, one can directly calculate the middle of the rear axle and the middle of the front axle. The middle of the rear axle is calculated by averaging the 3D positions of the left rear wheel 3312 and the right rear wheel 3313 using conventional visual techniques. The middle of the front axle is calculated by averaging the 3D positions of the left front wheel 3310 and the right front wheel 3311. The vector from the mid-rear axle to mid-front axle is demonstrated in 3316, which is the GCL.

In a drive direction aligner described herein, a mathematically equivalent GCL direction can be measured despite not directly measuring the left to right side transformation. The vector from the center of the left rear wheel 3312 to the left front wheel 3310 is denoted by 3314. The vector from the center of the right rear wheel 3313 to the right front wheel 3311 is denoted by 3315. When rear to front wheel vectors 3314 and 3315 are averaged, the vector is mathematically equivalent to the previously described GCL vector 3316.

The thrust direction 3317 is calculated based on the rear toe angles with respect to the GCL 3316. The front toe angles are calculated with respect to the thrust direction 3317.

### Calibration of Vehicle Rolling Surface With Respect to Gravity

To measure camber in a way that is independent of the tilt of the rolling surface with respect to gravity, we must measure the tilt of the rolling surface (e.g., an alignment lift) with respect to gravity. After we have performed this calibration, we can characterize the orientation of the plane of the alignment lift in the inclinometer coordinate system, and from there (using other calibrations and live measurements) transform the normal of the alignment lift to other coordinate systems.

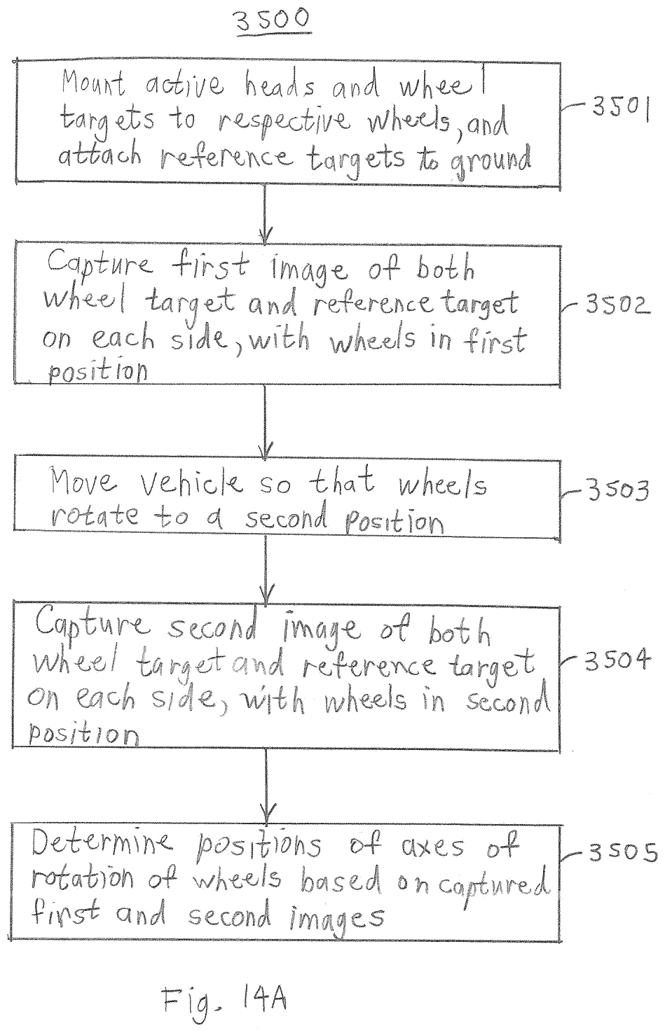

There are various methods by which this lift orientation with respect to gravity can be performed. One method is depicted in FIG. 13. The essence of this method is to view targets of known geometry 3400a-d from a static camera/inclinometer assembly 3410, where the calibration between the inclinometer and camera is known from a previously described calibration. The targets 3400a-d are positioned on the alignment lift 3420 at approximately the locations of the vehicle tires. The positions of the targets 3400a-d in the camera coordinate system at all four wheel locations is measured. A best fit plane 3430 is calculated from these four points, and the normal of this best fit plane 3430 is calculated in the camera coordinate system. Using the known calibration between the camera and the inclinometer, the orientation of the best fit plane normal in the inclinometer coordinate system can be determined. The tilt angle between the alignment lift best fit normal direction and the gravity direction can then be determined using standard trigonometric functions and stored for later use.

### Defining the Basis Vectors of the VCS

The three mutually orthonormal 3D Cartesian basis vectors that define the orientation of the VCS are defined from the geometric quantities defined above. The Y axis of the VCS, corresponding to the longitudinal axis of the vehicle, is defined as the GCL. The Z axis of the VCS corresponds to the vertical dimension of the vehicle, and is approximately aligned with the direction of gravity. We use the previously performed calibration of the alignment lift with respect to gravity to determine the transformation from the measured gravity vector to the orientation of the alignment lift normal in the inclinometer coordinate system. The alignment lift normal is transformed from the inclinometer coordinate system to the left camera coordinate system—this transformed vector constitutes the Z axis of the VCS. The alignment lift normal is further orthogonalized to remove the component that is parallel to the measured vehicle drive direction. The VCS X axis is then defined as the cross product of the VCS Y axis and the VCS Z axis.

### Calculation of Basic Alignment Angles

Once the VCS has been determined and all wheel axes have been measured and transformed into the VCS, the alignment angles can then be determined in a well-known manner. The wheel axes are projected onto various 2D planes of the vehicle coordinate system. Camber angle is defined from the elevation angle of the wheel axes with respect to the VCS (X, Y) plane. The previously described tilt angle of the alignment lift with respect to gravity must also be incorporated and subtracted from the calculated camber angles. Rear toe angles are calculated with respect to the Geometric Center Line 3316 as described above. Front wheel toe angles are defined with respect to the vehicle thrust line 3317 as described above.

### Description of an Implementation of Drive Direction in a Vehicle Aligner

FIG. 10 shows an implementation example in which a wheel alignment is being performed on a vehicle using an active-head wheel alignment system and a drive direction calculation.

As shown in FIG. 10, passive heads including wheel targets 3080L, 3080R are rigidly mounted to the front wheels 3022L, 3022R of the vehicle 3030 using a wheel clamp (e.g., 500 of FIG. 3A). A pair of active heads 3020L, 3020R each including an alignment camera 3010L, 3010R and a gravity sensor 3102L, 3102R are mounted to the rear wheels 3024L, 3024R of the vehicle 3030. A pair of reference targets 3070L, 3070R rigidly attached to the rolling surface 3040 that the vehicle 3030 is supported on with a reference support. Each of the reference targets 3070L, 3070R are positioned within the FOV of a corresponding alignment camera 3010L, 3010R such that it can be seen by the camera.

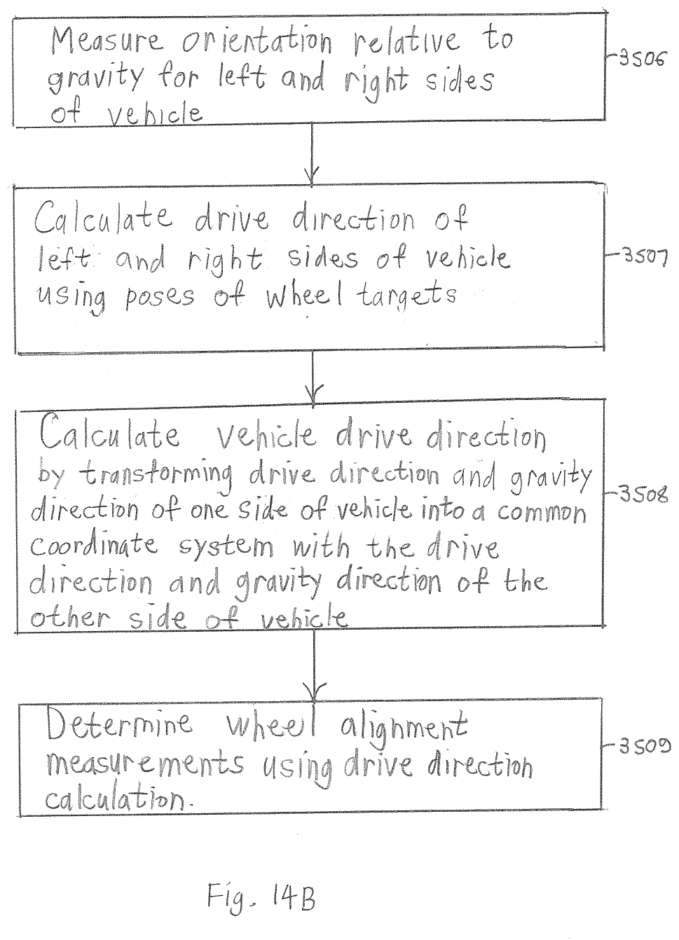

In operation, as shown in the procedure 3500 of FIG. 14A, the active heads 3020L, 3020R having alignment cameras 3010L, 3010R and gravity sensors 3102L, 3102R; and wheel targets 3080L, 3080R are mounted to respective wheels of the vehicle 3030, and the reference targets 3070L, 3070R are attached to a stationary reference, in step 3501. In step 3502, the alignment cameras 3010L, 3010R then capture a first image of both the respective wheel targets 3080L, 3080R and the reference targets 3070L, 2070R, and the positions of the wheel targets and of the reference targets with respect to the cameras are calculated based on the captured first image. The vehicle 3030 is then moved (e.g., moved forward by approximately 8″) in step 3503. The alignment cameras 3010L, 3010R then capture a second image of the wheel targets 3080L, 3080R and reference targets 3070L, 3070R in step 3504, and the positions of the wheel targets and of the reference targets with respect to the cameras are calculated based on the captured second image. The position (and orientation) of the axis of rotation of each of the rear wheels 3024L, 3024R, corresponding to the wheel on which the active head having the alignment camera is mounted, is calculated based on the change in position of the reference targets 3070L, 3070R in the first and second images captured at the two camera positions, in step 3505.

Additionally, also in step 3505, the position (and orientation) of the axis of rotation of each of the front wheels, corresponding to the wheel on which the passive head having the alignment target is mounted, is calculated by firstly transforming the front wheel target's position into the corresponding reference target's coordinate system at each vehicle position, and secondly calculating the axis of rotation from the change of position of the front wheel target in the corresponding reference target coordinate system. Based on these computations, the two wheel axes' positions are determined on one side of the vehicle. A similar process can be performed on the other side of the vehicle to determine the two wheel axes' positions on the other side of the vehicle.

Next, as discussed herein above, a drive direction of the vehicle is calculated using the calculated poses of the first and second wheel targets 3080L, 3080R and the sensed orientation relative to gravity on the first and second sides of the vehicle. In step 3506, an orientation relative to gravity on the first side of the vehicle is measured using first gravity sensor 3102L attached to the first camera 3010L; and an orientation relative to gravity on the second side of the vehicle is measured using second gravity sensor 3102R attached to the second camera 3010R.

A drive direction of the first side of the vehicle is then calculated using the calculated poses of the first wheel target 3080L, and a drive direction of the second side of the vehicle is calculated using the calculated poses of the second wheel target 3080R, at step 3507. The drive direction and gravity direction of the first side of the vehicle is then transformed into a common coordinate system with the drive direction and gravity direction of the second side of the vehicle to obtain the vehicle drive direction, in step 3508. Wheel alignment measurements are then calculated as discussed herein above using the vehicle drive direction calculation, at step 3509.

In the foregoing description, the active heads 3020L, 3020R are described as each being attached to a rear wheel and the targets 3080L, 3080R are described as each being attached to a front wheel of the vehicle. However, the targets 3080L, 3080R could be attached to the rear wheels and the active heads 3020L, 3020R to the front wheels. The reference targets 3070L, 3070R could be attached to a rack, floor, tripod, or other type of attachment.

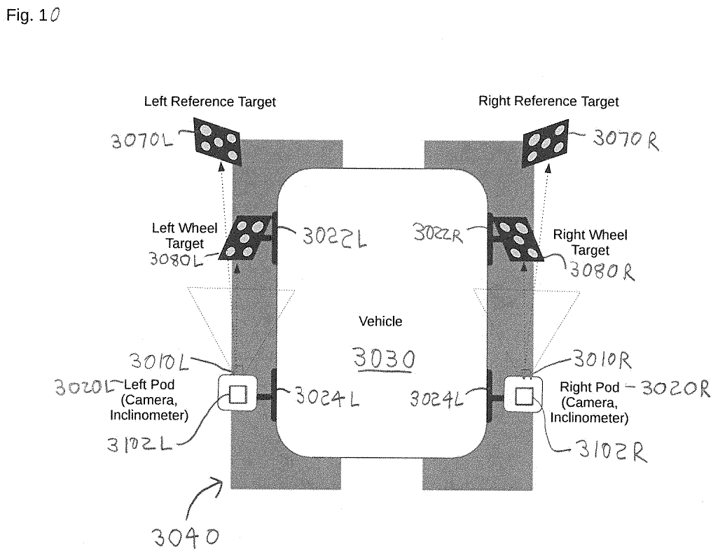

FIG. 9 provides a functional block diagram illustration of a computer hardware platform configured for use in the vehicle alignment systems described above to provide the functionality of the systems as described. As shown in FIG. 9, a host computer platform includes a data communication interface for data communication with one or more alignment or calibration cameras such as those described above. The computer platform also includes a central processing unit (CPU), in the form of one or more processors, for executing program instructions. The computer platform typically includes an internal communication bus, program storage and data storage for various data files to be processed, and an input/output interface for communication with one or more users or other networked devices. The computer platform may additionally be configured to send and receive programming, data, and control instructions via network communications. Of course, the computer functions may be implemented in a distributed fashion on a number of similar platforms, to distribute the processing load.

The host computer platform is communicatively connected to the alignment or calibration cameras through wired or wireless communication links. For this purpose, the host computer platform and each camera has a wired or wireless communication transceiver therein. In particular, in the case of a wireless communication link, the host computer platform and the camera(s) each have a wireless transceiver through which a wireless communication link can be established. The wired or wireless communication links are used to communicate captured image data from the camera(s) to the host computer platform, and can also be used to communicate control commands or software updates from the host computer platform to the camera(s).

In operation, when a wheel alignment procedure or a calibration procedure is performed, the CPU of the host computer platform causes one or more connected alignment and/or calibration camera(s) to capture images. Typically, the images are captured so as to show therein one or more alignment or reference targets according to which positions can be determined. A single image or plural images are captured, including images captured prior to and following movement of the vehicle notably in situations in which an axis of rotation of a wheel is to be determined.

The host computer platform can store the captured images in memory. Additionally, known positional relationships (when known) are stored in memory including, for example, a known positional relationship between a calibration camera (e.g., 300) and a reference target (e.g., 200) of a side-to-side reference system 100; a known positional relationship between a calibration target (e.g., 310) and a reference target (e.g., 210); a known positional relationship between two cameras (120, 140) that are mounted together in a camera assembly; and the like.

The host computer platform is operative to process the captured images in order to identify the alignment targets or reference targets therein, and to determine the position of the alignment targets or reference targets relative to the cameras based on the locations of the targets in the captured images. For example, methods such as those described in U.S. Pat. Nos. 7,313,869 and 7,369,222, and 7,415,324, which are hereby incorporated by reference in their entireties. In turn, the host computer platform can determine the alignment of the vehicle wheels based on the determined positions of the targets relative to the cameras and the further steps detailed herein, including steps based on the stored positional relationship data described above.

As such, aspects of the alignment measurement methods detailed above may be embodied in programming stored in the memory of the computer platform and configured for execution on the CPU of the computer platform. Furthermore, data on alignment targets including known relative position data of targets and/or cameras, data on alignment and calibration cameras, and the like, may be stored in the memory of the computer platform for use in computing alignment measurements.

The drawing figures presented in this document depict one or more implementations in accord with the present teachings, by way of example only, not by way of limitation. In the figures, like reference numerals refer to the same or similar elements.

In the foregoing detailed description, numerous specific details are set forth by way of examples in order to provide a thorough understanding of the relevant teachings. However, it should be apparent to those skilled in the art that the present teachings may be practiced without such details. In other instances, methods, procedures, components, and/or circuitry have been described at a relatively high-level, without detail, in order to avoid unnecessarily obscuring aspects of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A wheel alignment system comprising:
a pair of first and second passive heads, each comprising a target, each for mounting in association with one wheel of a first pair of wheels disposed on first and second sides, respectively, of a vehicle that is to be measured by operation of the wheel alignment system;
a pair of reference targets for mounting to a stationary reference, the pair of reference targets including a first reference target disposed on one of the first and second sides of the vehicle, and a second reference target disposed on the other of the first and second sides of the vehicle;
a pair of first and second active heads for mounting in association with the first and second sides of the vehicle, respectively, the first active head comprising a first image sensor, the second active head comprising a second image sensor, the first image sensor producing image data of the first passive head and of the first reference target, the second image sensor producing image data of the second passive head and of the second reference target;
a first gravity sensor and a second gravity sensor, the first and second gravity sensors each disposed in a known relationship to a respective one of the first and second reference targets or a respective one of the first and second image sensors for measuring a sensed orientation relative to gravity on the first and second sides of the vehicle, respectively;
a data processor for performing the steps of:
calculating, using the image data, a plural number of poses of each of the first and second passive heads as the first pair of wheels is rotated;
calculating a drive direction of the vehicle using the calculated poses of the first and second passive heads and the sensed orientation relative to gravity on the first and second sides of the vehicle; and
calculating a wheel alignment measurement using the vehicle drive direction.

2. The wheel alignment system of claim 1, wherein calculating the drive direction of the vehicle comprises:
calculating a drive direction of the first side of the vehicle using the calculated poses of the first target, and a drive direction of the second side of the vehicle using the calculated poses of the second target;
calculating a gravity direction on the first side of the vehicle using the measured orientation relative to gravity of the first gravity sensor, and a gravity direction on the second side of the vehicle using the measured orientation relative to gravity of the second gravity sensor; and
transforming the drive direction and gravity direction of the first side of the vehicle into a common coordinate system with the drive direction and gravity direction of the second side of the vehicle.

3. The wheel alignment system of claim 1, wherein the stationary reference having the first and second reference pods mounted thereon is a ground, a rack, or a lift.

4. The wheel alignment system of claim 1, wherein the first and second active heads are for mounting to a stationary reference.

5. The wheel alignment system of claim 1, wherein the first and second active heads are for mounting to the vehicle that is to be measured by operation of the wheel alignment system.

6. The wheel alignment system of claim 5, wherein the first and second active heads are for mounting in association with a second pair of wheels disposed on the first and second sides of the vehicle.

7. The wheel alignment system of claim 1, wherein the first active head includes the first gravity sensor, and the second active head includes the second gravity sensor.

8. The wheel alignment system of claim 1, wherein the first and second gravity sensors each comprise an inclinometer, an accelerometer, or a plumb line.

9. A method for measuring an alignment of a vehicle comprising:
attaching a pair of first and second passive heads, each comprising a target, in association with a first pair of wheels disposed on first and second sides, respectively, of the vehicle to be measured;
providing a pair of reference targets mounted to a stationary reference, the pair of reference targets including a first reference target disposed on one of the first and second sides of the vehicle, and a second reference target disposed on the other of the first and second sides of the vehicle;
capturing, using a first image sensor of a first active head mounted in association with the first side of the vehicle, image data of the first passive head and of the first reference target;
capturing, using a second image sensor of a second active head mounted in association with the second side of the vehicle, image data of the second passive head and of the second reference target;
measuring, using a first gravity sensor disposed in a known relationship to the first reference target or the first image sensor, an orientation relative to gravity on the first side of the vehicle;
measuring, using a second gravity sensor disposed in a known relationship to the second reference target or the second image sensor, an orientation relative to gravity on the second side of the vehicle;
processing the image data from the image sensors to calculate a plural number of poses of each of the first and second passive heads as the first pair of wheels is rotated;
calculating a drive direction of the vehicle using the calculated poses of the first and second passive heads and the measured orientation relative to gravity on the first and second sides of the vehicle; and
calculating a wheel alignment measurement using the vehicle drive direction.

10. The method of claim 9, wherein calculating the drive direction of the vehicle comprises:
calculating a drive direction of the first side of the vehicle using the calculated poses of the first target, and a drive direction of the second side of the vehicle using the calculated poses of the second target;
calculating a gravity direction on the first side of the vehicle using the measured orientation relative to gravity of the first gravity sensor, and a gravity direction on the second side of the vehicle using the measured orientation relative to gravity of the second gravity sensor; and
transforming the drive direction and gravity direction of the first side of the vehicle into a common coordinate system with the drive direction and gravity direction of the second side of the vehicle.

11. The method of claim 9, further comprising mounting the first and second reference targets to the stationary reference prior to capturing image data using the image sensors of the first and second active heads, wherein the stationary reference is a ground, a rack, or a lift.

12. The method of claim 9, further comprising mounting the first and second active heads to a stationary reference prior to capturing image data using the image sensors of the first and second active heads.

13. The method of claim 9, further comprising mounting the first and second active heads in association with the vehicle that is to be measured by operation of the wheel alignment system prior to capturing image data using the images sensors of the first and second active heads.

14. The method of claim 13, wherein the mounting comprises mounting the first and second active heads in association with a second pair of wheels disposed on the first and second sides of the vehicle.

15. A wheel alignment system comprising:
a pair of first and second passive heads, each comprising a target, each for mounting in association with one wheel of a first pair of wheels disposed on first and second sides, respectively, of a vehicle that is to be measured by operation of the wheel alignment system;
a pair of reference targets for mounting to a stationary reference, the pair of reference targets including a first reference target disposed on one of the first and second sides of the vehicle, and a second reference target disposed on the other of the first and second sides of the vehicle;
a pair of first and second active heads for mounting in association with the first and second sides of the vehicle, respectively, the first active head comprising a first image sensor, the second active head comprising a second image sensor, the first image sensor producing image data of the first passive head and of the first reference target, the second image sensor producing image data of the second passive head and of the second reference target;
a first common direction sensor and a second common direction sensor, the first and second common direction sensors each disposed in a known relationship to a respective one of the first and second reference targets or a respective one of the first and second image sensors for measuring a common direction on the first and second sides of the vehicle, respectively;
a data processor for performing the steps of:
calculating, using the image data, a plural number of poses of each of the first and second passive heads as the first pair of wheels is rotated;
calculating a drive direction of the vehicle using the calculated poses of the first and second passive heads and the sensed common direction on the first and second sides of the vehicle; and
calculating a wheel alignment measurement using the vehicle drive direction.

16. The wheel alignment system of claim 15, wherein the first and second common direction sensors each comprise a magnetometer for measuring a direction to the magnetic north pole on one of the first and second sides of the vehicle, respectively.

17. The wheel alignment system of claim 15, wherein the first and second common direction sensors each comprise a gyroscope for measuring a direction on one of the first and second sides of the vehicle, respectively.

18. The wheel alignment system of claim 15, wherein the first and second common direction sensors each comprise an absolute orientation sensor for measuring a direction on one of the first and second sides of the vehicle, respectively.
